(19) United States
(12) Patent Application Publication
(10) Pub. No.: US 2022/0366820 A1
(43) Pub. Date: Nov. 17, 2022

(54) VIEWPORT VISUAL EFFECT CORRECTION

(71) Applicant: Meta Platforms Technologies, LLC, Menlo Park, CA (US)

(72) Inventors: Nilanjan Goswami, Livermore, CA (US); Michael Yee, Woodinville, WA (US); Morgyn Taylor, Danville, CA (US); Patrick Mccleary, Seattle, WA (US); Naveen Makineni, Seattle, WA (US); Aaron Young, Seattle, WA (US); Zhi Zhou, Issaquah, WA (US); Richard Lawrence Greene, Redmond, WA (US); Richard Webb, Sammamish, WA (US); Cheng Chang, Redmond, WA (US)

(21) Appl. No.: 17/875,131

(22) Filed: Jul. 27, 2022

Related U.S. Application Data
(60) Provisional application No. 63/233,968, filed on Aug. 17, 2021.
(60) Provisional application No. 63/234,043, filed on Aug. 17, 2021.
(60) Provisional application No. 63/228,287, filed on Aug. 2, 2021.
(60) Provisional application No. 63/234,841, filed on Aug. 19, 2021.

(51) Int. Cl. G09G 3/00; G06T 3/40; G06T 9/00

(52) U.S. Cl. CPC G09G 3/001; G06T 3/40; G06T 9/00; G09G 2320/0242; G09G 2340/0407

(57) ABSTRACT

In one embodiment, one or more computing systems may determine a first display content to be displayed on a display. The first display content may be associated with one or more frames. The one or more computing systems may determine an optimization operation for the first display content based on one or more first parameters associated with the display or one or more second parameters associated with the one or more frames. The one or more computing systems may adjust the one or more frames based on the optimization operation. The adjusted one or more frames may have at least one optimized attribute comparing to the one or more frames before being adjusted. The one or more computing systems may output the adjusted one or more frames to the display to represent the first display content.

### PRIORITY

This application claims the benefit under 35 U.S.C. § 119(e) of U.S. Provisional Patent Application No. 63/233,968, filed 17 Aug. 2021, which is incorporated herein by reference. This application claims the benefit under 35 U.S.C. § 119(e) of U.S. Provisional Patent Application No. 63/234,043, filed 17 Aug. 2021, which is incorporated herein by reference. This application claims the benefit under 35 U.S.C. § 119(e) of U.S. Provisional Patent Application No. 63/228,287, filed 2 Aug. 2021, which is incorporated herein by reference. This application claims the benefit under 35 U. S.C. § 119(e) of U.S. Provisional Patent Application No. 63/234,841, filed 19 Aug. 2021, which is incorporated herein by reference.

### TECHNICAL FIELD

This disclosure generally relates to artificial reality, such as virtual reality and augmented reality.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Artificial reality involves the display of computer-generated graphics to a user in an immersive manner. The goal is to cause the user to experience the computer-generated graphics as though they existed in the world before them. Rendering computer-generated graphics for artificial reality is a computationally-intensive task, often requiring expensive and specialized hardware. This is due at least in part to the requirement that the graphics displayed to the user must be very high quality. For a user to believe that the graphics represent, or are a part of, the world around them, the graphics must be believably high quality. The screen-door effect, where either the graphics or the display used to project the graphics allow the user to see lines between pixels can ruin any sense of immersion. Furthermore, graphics for artificial reality scenes are often interactive—when a user “moves” in the virtual space, the space moves with or in response to them. Latency between a user's movement, or movement command, and displaying the effects of that movement can cause great discomfort to the user, such as virtual-reality sickness. Because a user's movements are typically unpredictable, pre-rendering most components of an artificial reality scene is impractical.

### BRIEF DESCRIPTION OF THE DRAWINGS

FIG. 1A illustrates an example artificial reality system.

FIG. 1B illustrates an example augmented reality system.

FIG. 1C illustrates an example architecture of a display engine.

FIG. 1D illustrates an example graphic pipeline of the display engine for generating display image data.

FIG. 2A illustrates an example scanning waveguide display.

FIG. 2B illustrates an example scanning operation of the scanning waveguide display.

FIG. 3A illustrates an example 2D micro-LED waveguide display.

FIG. 3B illustrates an example waveguide configuration for the 2D micro-LED waveguide display.

FIG. 4A illustrates an example viewport having corner cutouts.

FIG. 4B illustrates an example view port with the fade-away effect.

FIG. 4C illustrates an example scheme for design the attenuation function to create the fade-away effect.

FIGS. 4D and 4E illustrate example attenuation functions for creating the fade-away effect.

FIG. 5 illustrates an example framework for creating a fade-away effect for an octagonal view port.

FIG. 6 illustrates an example method for generating a fade-away effect for a view port of a display.

FIG. 7 illustrates example processes for determining workload for generating the current frame based on the workload of previous frames.

FIG. 8A illustrates an example process for dynamically allocating computational resources.

FIG. 8B illustrates an example process for dynamically adjusting the ratio of foveated rendering.

FIG. 9 illustrates an example method for dynamically adjusting computational capacity based on estimated amount of computation for the current frame.

FIG. 10A illustrates a boost converter gate drive circuitry.

FIG. 10B illustrates first timing signals without the present modulated PWM techniques and second timing signals with the present modulated PWM techniques.

FIG. 11 illustrates an open loop PWM modulation topology and closed loop PWM modulation topology.

FIG. 12 illustrates an analog example of an open loop PWM modulation topology and closed loop PWM modulation topology.

FIG. 13 illustrates an artificial reality graphics rendering and display system.

FIG. 14 illustrates a system diagram for a display engine.

FIG. 15 illustrates pixel color values of pixel blocks.

FIG. 16 illustrates pixel color values of pixel blocks.

FIG. 17 illustrates an image being selectively encoded.

FIG. 18 illustrates images being selectively encoded.

FIGS. 19A-19C illustrate examples of uncompressed pixel arrays and compressed pixel arrays.

FIG. 20 is a flow diagram of a method encoding pixel blocks of an image based on joint-color mode.

FIG. 21 is a flow diagram of a method for compressing pixel arrays based on quantization levels.

FIG. 22 illustrates an example network environment associated with a social-networking system.

FIG. 23 illustrates an example computer system.

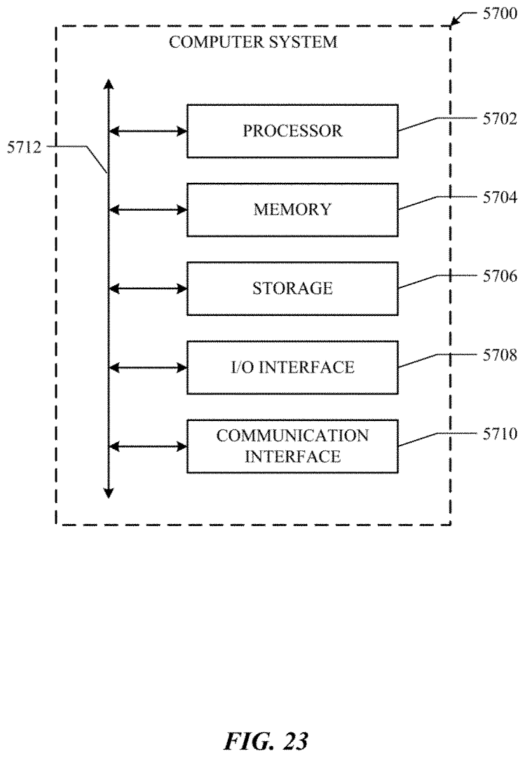

### DESCRIPTION OF EXAMPLE EMBODIMENTS

### Viewport Visual Effect Correction

Particular embodiments described herein relate to systems and methods of using a fade-away effect to improve viewport appearance. To address the limitation of waveguides, an originally rectangular viewport may have cutout-corners and may have an octagonal shape, which may lead to a non-optimal visual experience to users. To address this problem, the system may use the per-pixel correction provided by the non-uniformity correction (NUC) mechanism to blur the edges of the viewport based on the particular waveguide characteristics of each headset. The system may determine, based on the waveguide characteristics of the viewport, a scaling factor for each pixel value in the image to be displayed. The scaling factors, once applied to the pixel values of the image, may create a fade-away effect on the edges and corners of the image by modifying the pixel values in the image. As a result, the viewport may be blurred in the areas close to its edges or corners and the octagonal visual effect of viewport may be smoothed, leading to a more optimal visual experience for users. The system may adaptively compute the blurring coefficients based on on-device evaluations of LED wear-out and may combine the blurring coefficients with the scaling factor matrix for non-uniformity correction. As a result, the system may adjust the pixel values of the images for creating the fade-away effect during the non-uniformity correction process.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

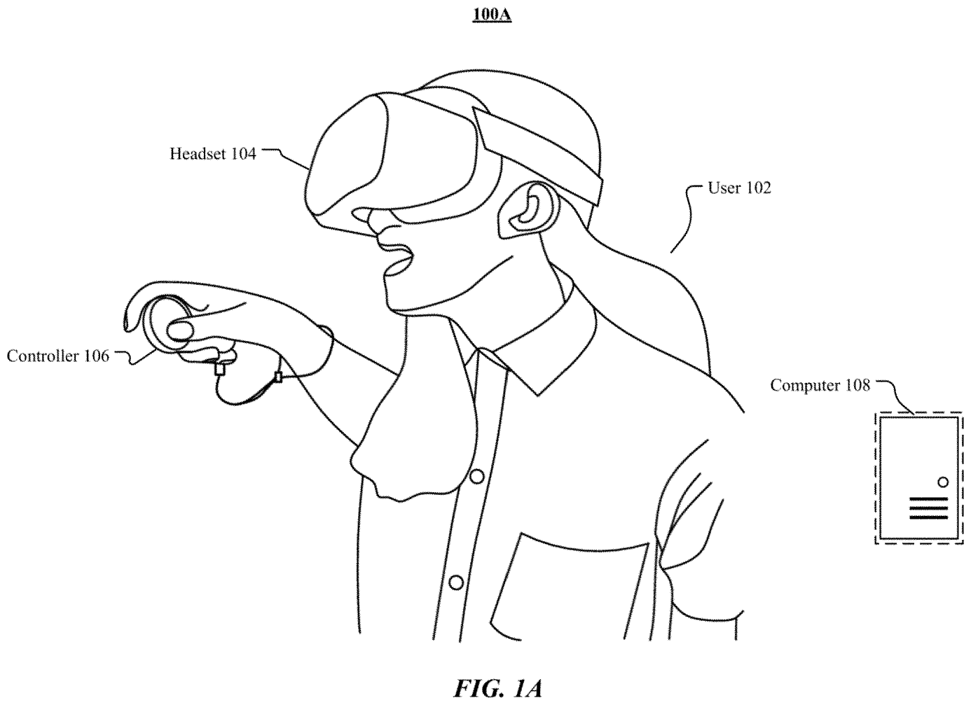

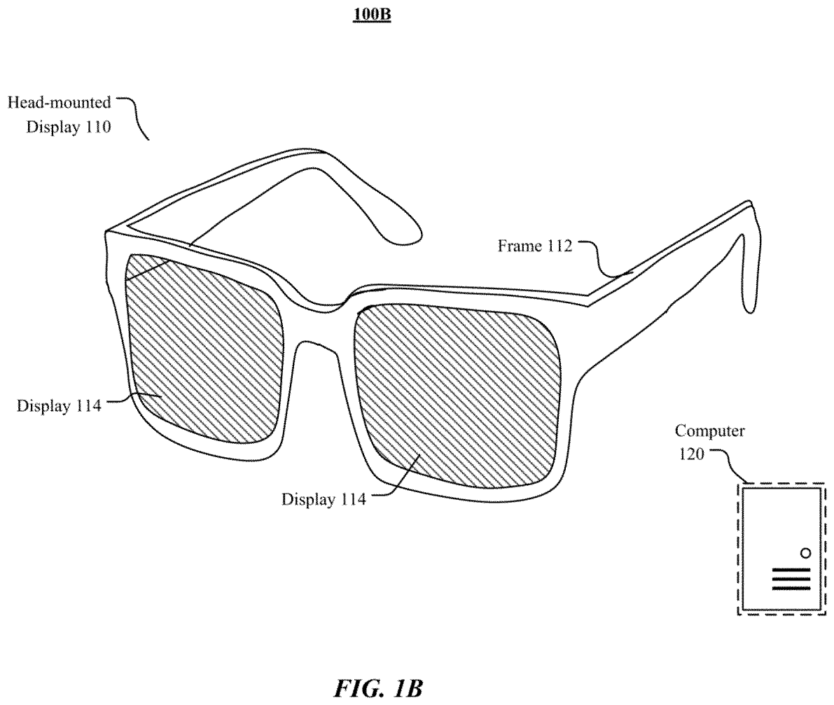

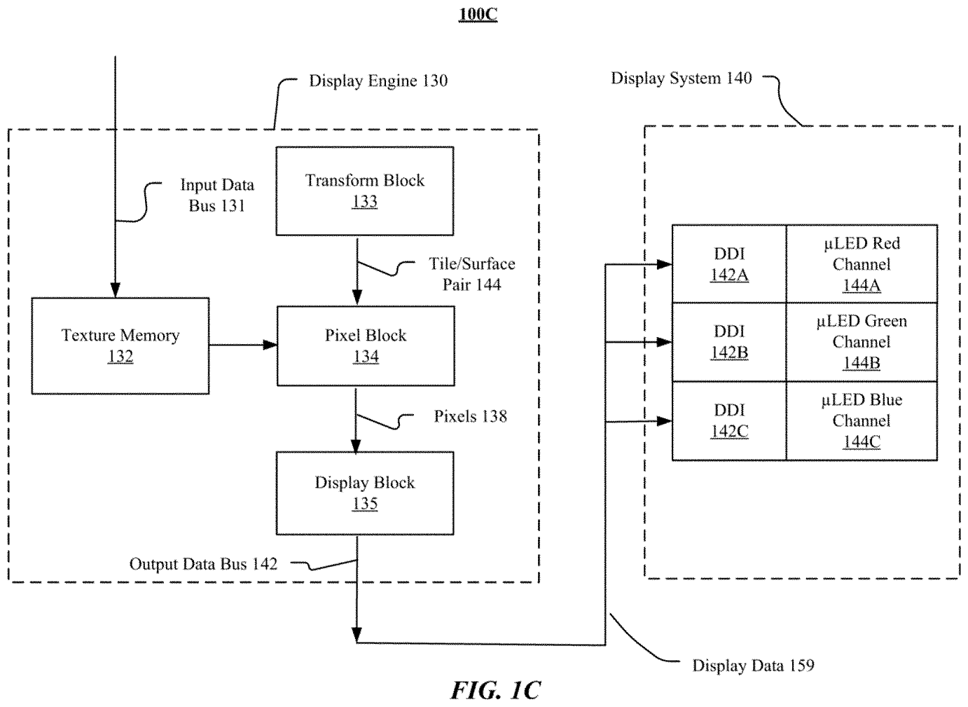

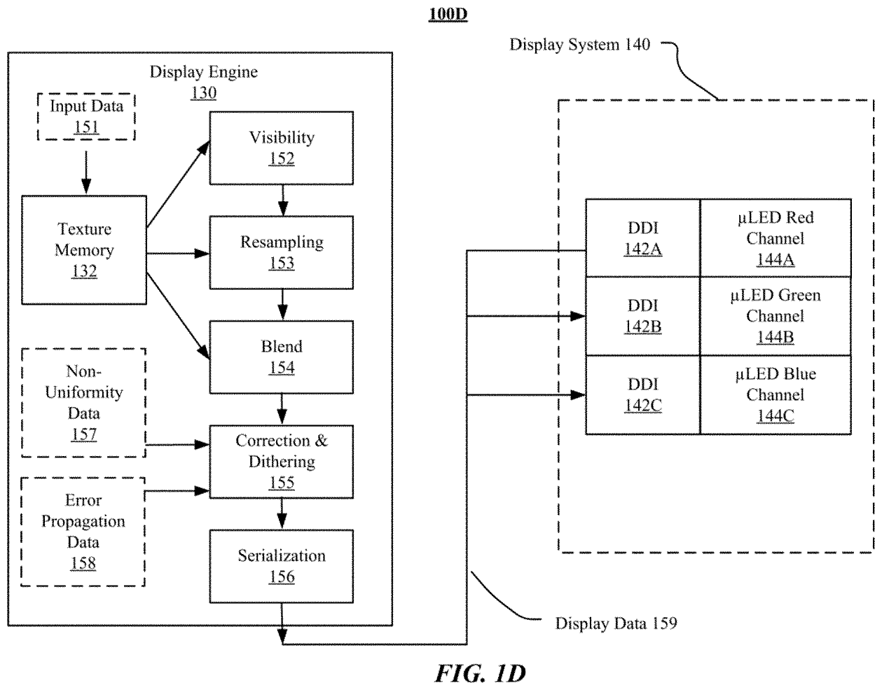

FIG. 1A illustrates an example artificial reality system 100A. In particular embodiments, the artificial reality system 100 may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may be referred as a head-mounted display (HDM). The controller 106 may comprise a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

FIG. 1C illustrates an example architecture 100C of a display engine 130. In particular embodiments, the processes and methods as described in this disclosure may be embodied or implemented within a display engine 130 (e.g., in the display block 135). The display engine 130 may include, for example, but is not limited to, a texture memory 132, a transform block 133, a pixel block 134, a display block 135, input data bus 131, output data bus 142, etc. In particular embodiments, the display engine 130 may include one or more graphic pipelines for generating images to be rendered on the display. For example, the display engine may use the graphic pipeline(s) to generate a series of subframe images based on a mainframe image and a viewpoint or view angle of the user as measured by one or more eye tracking sensors. The mainframe image may be generated or/and loaded in to the system at a mainframe rate of 30-90 Hz and the subframe rate may be generated at a subframe rate of 1-2 kHz. In particular embodiments, the display engine 130 may include two graphic pipelines for the user's left and right eyes. One of the graphic pipelines may include or may be implemented on the texture memory 132, the transform block 133, the pixel block 134, the display block 135, etc. The display engine 130 may include another set of transform block, pixel block, and display block for the other graphic pipeline. The graphic pipeline(s) may be controlled by a controller or control block (not shown) of the display engine 130. In particular embodiments, the texture memory 132 may be included within the control block or may be a memory unit external to the control block but local to the display engine 130. One or more of the components of the display engine 130 may be configured to communicate via a high-speed bus, shared memory, or any other suitable methods. This communication may include transmission of data as well as control signals, interrupts or/and other instructions. For example, the texture memory 132 may be configured to receive image data through the input data bus 211. As another example, the display block 135 may send the pixel values to the display system 140 through the output data bus 142. In particular embodiments, the display system 140 may include three color channels (e.g., 114A, 114B, 114C) with respective display driver ICs (DDIs) of 142A, 142B, and 143B. In particular embodiments, the display system 140 may include, for example, but is not limited to, light-emitting diode (LED) displays, organic light-emitting diode (OLED) displays, active matrix organic light-emitting diode (AMLED) displays, liquid crystal display (LCD), micro light-emitting diode (μLED) display, electroluminescent displays (ELDs), or any suitable displays.

In particular embodiments, the display engine 130 may include a controller block (not shown). The control block may receive data and control packages such as position data and surface information from controllers external to the display engine 130 though one or more data buses. For example, the control block may receive input stream data from a body wearable computing system. The input data stream may include a series of mainframe images generated at a mainframe rate of 30-90 Hz. The input stream data including the mainframe images may be converted to the required format and stored into the texture memory 132. In particular embodiments, the control block may receive input from the body wearable computing system and initialize the graphic pipelines in the display engine to prepare and finalize the image data for rendering on the display. The data and control packets may include information related to, for example, one or more surfaces including texel data, position data, and additional rendering instructions. The control block may distribute data as needed to one or more other blocks of the display engine 130. The control block may initiate the graphic pipelines for processing one or more frames to be displayed. In particular embodiments, the graphic pipelines for the two eye display systems may each include a control block or share the same control block.

In particular embodiments, the transform block 133 may determine initial visibility information for surfaces to be displayed in the artificial reality scene. In general, the transform block 133 may cast rays from pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye tracking sensors, and/or any suitable tracking/localization algorithms, such as simultaneous localization and mapping (SLAM)) into the artificial scene where surfaces are positioned and may produce tile/surface pairs 144 to send to the pixel block 134. In particular embodiments, the transform block 133 may include a four-stage pipeline as follows. A ray caster may issue ray bundles corresponding to arrays of one or more aligned pixels, referred to as tiles (e.g., each tile may include 16×16 aligned pixels). The ray bundles may be warped, before entering the artificial reality scene, according to one or more distortion meshes. The distortion meshes may be configured to correct geometric distortion effects stemming from, at least, the eye display systems the headset system. The transform block 133 may determine whether each ray bundle intersects with surfaces in the scene by comparing a bounding box of each tile to bounding boxes for the surfaces. If a ray bundle does not intersect with an object, it may be discarded. After the tile-surface intersections are detected, the corresponding tile/surface pairs may be passed to the pixel block 134.

In particular embodiments, the pixel block 134 may determine color values or grayscale values for the pixels based on the tile-surface pairs. The color values for each pixel may be sampled from the texel data of surfaces received and stored in texture memory 132. The pixel block 134 may receive tile-surface pairs from the transform block 133 and may schedule bilinear filtering using one or more filer blocks. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation). In particular embodiments, the pixel block 134 may process the red, green, and blue color components separately for each pixel. In particular embodiments, the display may include two pixel blocks for the two eye display systems. The two pixel blocks of the two eye display systems may work independently and in parallel with each other. The pixel block 134 may then output its color determinations (e.g., pixels 138) to the display block 135. In particular embodiments, the pixel block 134 may composite two or more surfaces into one surface to when the two or more surfaces have overlapping areas. A composed surface may need less computational resources (e.g., computational units, memory, power, etc.) for the resampling process.

In particular embodiments, the display block 135 may receive pixel color values from the pixel block 134, covert the format of the data to be more suitable for the scanline output of the display, apply one or more brightness corrections to the pixel color values, and prepare the pixel color values for output to the display. In particular embodiments, the display block 135 may each include a row buffer and may process and store the pixel data received from the pixel block 134. The pixel data may be organized in quads (e.g., 2×2 pixels per quad) and tiles (e.g., 16×16 pixels per tile). The display block 135 may convert tile-order pixel color values generated by the pixel block 134 into scanline or row-order data, which may be required by the physical displays. The brightness corrections may include any required brightness correction, gamma mapping, and dithering. The display block 135 may output the corrected pixel color values directly to the driver of the physical display (e.g., pupil display) or may output the pixel values to a block external to the display engine 130 in a variety of formats. For example, the eye display systems of the headset system may include additional hardware or software to further customize backend color processing, to support a wider interface to the display, or to optimize display speed or fidelity.

In particular embodiments, the dithering methods and processes (e.g., spatial dithering method, temporal dithering methods, and spatio-temporal methods) as described in this disclosure may be embodied or implemented in the display block 135 of the display engine 130. In particular embodiments, the display block 135 may include a model-based dithering algorithm or a dithering model for each color channel and send the dithered results of the respective color channels to the respective display driver ICs (DDIs) (e.g., 142A, 142B, 142C) of display system 140. In particular embodiments, before sending the pixel values to the respective display driver ICs (e.g., 142A, 142B, 142C), the display block 135 may further include one or more algorithms for correcting, for example, pixel non-uniformity, LED non-ideality, waveguide non-uniformity, display defects (e.g., dead pixels), etc.

In particular embodiments, graphics applications (e.g., games, maps, content-providing apps, etc.) may build a scene graph, which is used together with a given view position and point in time to generate primitives to render on a GPU or display engine. The scene graph may define the logical and/or spatial relationship between objects in the scene. In particular embodiments, the display engine 130 may also generate and store a scene graph that is a simplified form of the full application scene graph. The simplified scene graph may be used to specify the logical and/or spatial relationships between surfaces (e.g., the primitives rendered by the display engine 130, such as quadrilaterals or contours, defined in 3D space, that have corresponding textures generated based on the mainframe rendered by the application). Storing a scene graph allows the display engine 130 to render the scene to multiple display frames and to adjust each element in the scene graph for the current viewpoint (e.g., head position), the current object positions (e.g., they could be moving relative to each other) and other factors that change per display frame. In addition, based on the scene graph, the display engine 130 may also adjust for the geometric and color distortion introduced by the display subsystem and then composite the objects together to generate a frame. Storing a scene graph allows the display engine 130 to approximate the result of doing a full render at the desired high frame rate, while actually running the GPU or display engine 130 at a significantly lower rate.

FIG. 1D illustrates an example graphic pipeline 100D of the display engine 130 for generating display image data. In particular embodiments, the graphic pipeline 100D may include a visibility step 152, where the display engine 130 may determine the visibility of one or more surfaces received from the body wearable computing system. The visibility step 152 may be performed by the transform block (e.g., 2133 in FIG. 1C) of the display engine 130. The display engine 130 may receive (e.g., by a control block or a controller) input data 151 from the body-wearable computing system. The input data 151 may include one or more surfaces, texel data, position data, RGB data, and rendering instructions from the body wearable computing system. The input data 151 may include mainframe images with 30-90 frames per second (FPS). The main frame image may have color depth of, for example, 24 bits per pixel. The display engine 130 may process and save the received input data 151 in the texel memory 132. The received data may be passed to the transform block 133 which may determine the visibility information for surfaces to be displayed. The transform block 133 may cast rays for pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye trackers, and/or any suitable tracking/localization algorithms, such as simultaneous localization and mapping (SLAM)) into the artificial scene where surfaces are positioned and produce surface-tile pairs to send to the pixel block 134.

In particular embodiments, the graphic pipeline 100D may include a resampling step 153, where the display engine 130 may determine the color values from the tile-surfaces pairs to produce pixel color values. The resampling step 153 may be performed by the pixel block 134 in FIG. 1C) of the display engine 130. The pixel block 134 may receive tile-surface pairs from the transform block 133 and may schedule bilinear filtering. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation) and output the determined pixel values to the respective display block 135.

In particular embodiments, the graphic pipeline 100D may include a bend step 154, a correction and dithering step 155, a serialization step 156, etc. In particular embodiments, the bend step, correction and dithering step, and serialization steps of 154, 155, and 156 may be performed by the display block (e.g., 135 in FIG. 1C) of the display engine 130. The display engine 130 may blend the display content for display content rendering, apply one or more brightness corrections to the pixel color values, perform one or more dithering algorithms for dithering the quantization errors both spatially and temporally, serialize the pixel values for scanline output for the physical display, and generate the display data 159 suitable for the display system 140. The display engine 130 may send the display data 159 to the display system 140. In particular embodiments, the display system 140 may include three display driver ICs (e.g., 142A, 142B, 142C) for the pixels of the three color channels of RGB (e.g., 144A, 144B, 144C).

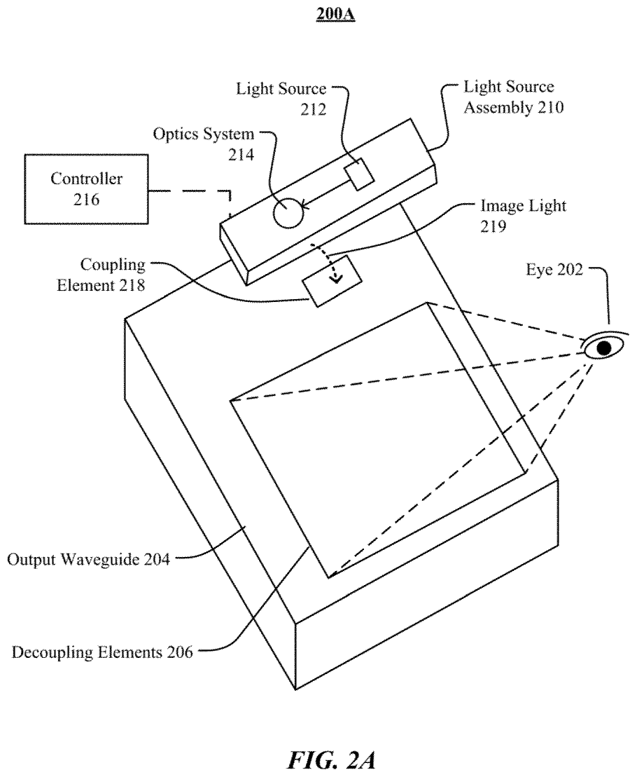

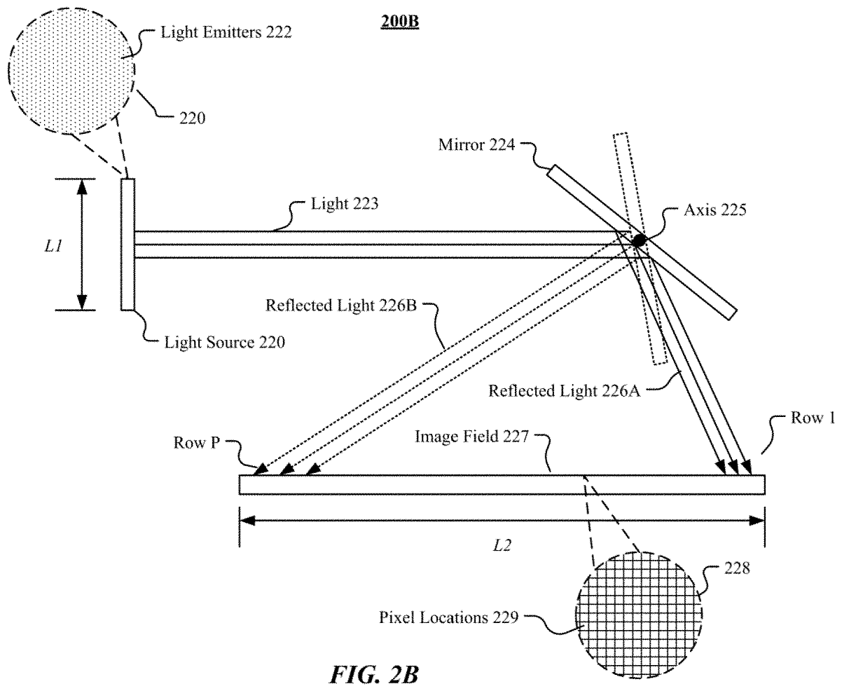

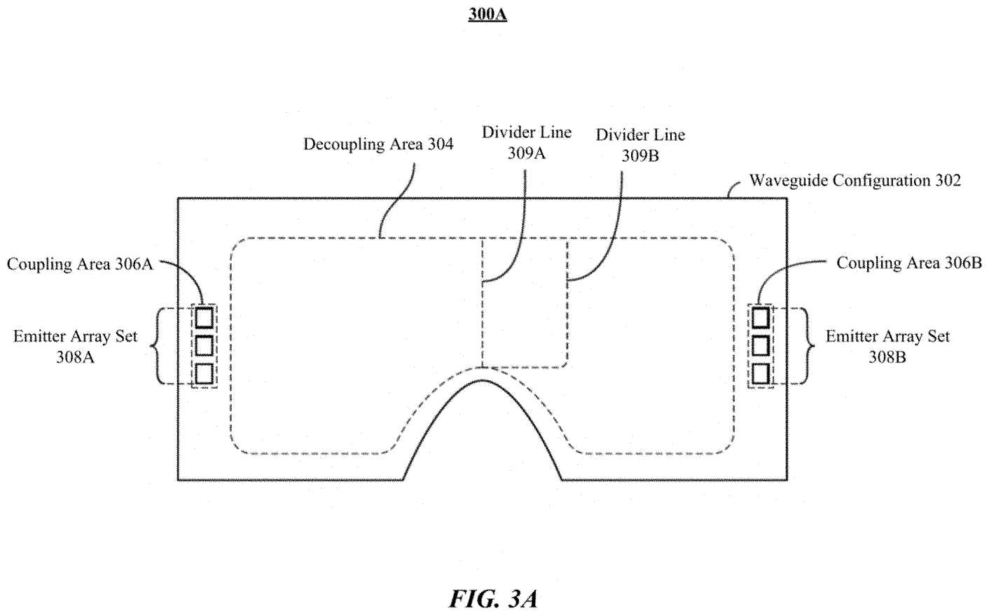

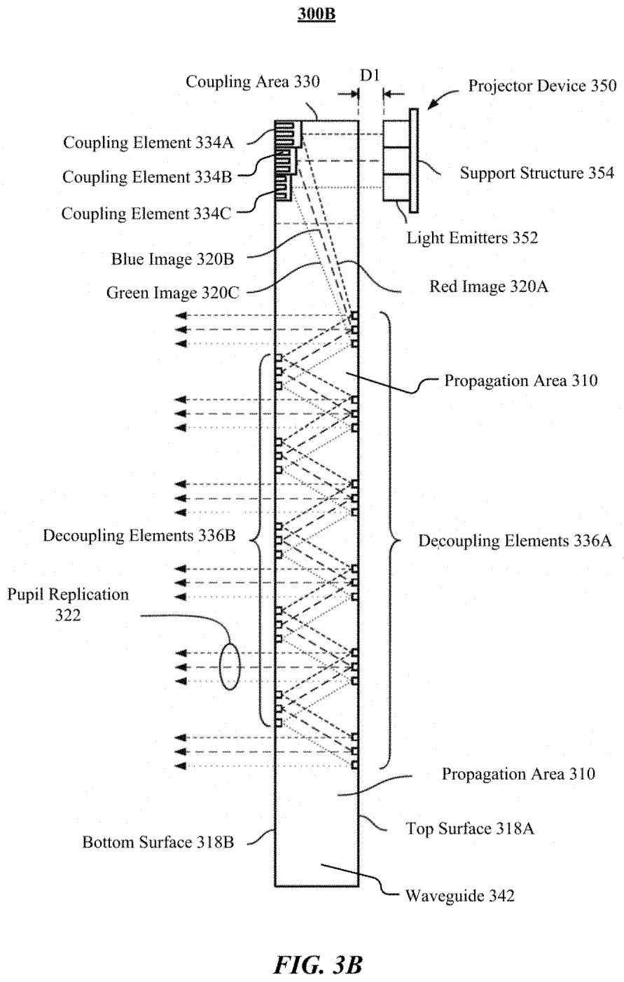

FIG. 2A illustrates an example scanning waveguide display 200A. In particular embodiments, the head-mounted display (HMD) of the AR/VR system may include a near eye display (NED) which may be a scanning waveguide display 200A. The scanning waveguide display 200A may include a light source assembly 210, an output waveguide 204, a controller 216, etc. The scanning waveguide display 200A may provide images for both eyes or for a single eye. For purposes of illustration, FIG. 3A shows the scanning waveguide display 200A associated with a single eye 202. Another scanning waveguide display (not shown) may provide image light to the other eye of the user and the two scanning waveguide displays may share one or more components or may be separated. The light source assembly 210 may include a light source 212 and an optics system 214. The light source 212 may include an optical component that could generate image light using an array of light emitters. The light source 212 may generate image light including, for example, but not limited to, red image light, blue image light, green image light, infra-red image light, etc. The optics system 214 may perform a number of optical processes or operations on the image light generated by the light source 212. The optical processes or operations performed by the optics systems 214 may include, for example, but are not limited to, light focusing, light combining, light conditioning, scanning, etc.

In particular embodiments, the optics system 214 may include a light combining assembly, a light conditioning assembly, a scanning mirror assembly, etc. The light source assembly 210 may generate and output an image light 219 to a coupling element 218 of the output waveguide 204. The output waveguide 204 may be an optical waveguide that could output image light to the user eye 202. The output waveguide 204 may receive the image light 219 at one or more coupling elements 218 and guide the received image light to one or more decoupling elements 206. The coupling element 218 may be, for example, but is not limited to, a diffraction grating, a holographic grating, any other suitable elements that can couple the image light 219 into the output waveguide 204, or a combination thereof. As an example and not by way of limitation, if the coupling element 350 is a diffraction grating, the pitch of the diffraction grating may be chosen to allow the total internal reflection to occur and the image light 219 to propagate internally toward the decoupling element 206. The pitch of the diffraction grating may be in the range of 300 nm to 600 nm. The decoupling element 206 may decouple the total internally reflected image light from the output waveguide 204. The decoupling element 206 may be, for example, but is not limited to, a diffraction grating, a holographic grating, any other suitable element that can decouple image light out of the output waveguide 204, or a combination thereof. As an example and not by way of limitation, if the decoupling element 206 is a diffraction grating, the pitch of the diffraction grating may be chosen to cause incident image light to exit the output waveguide 204. The orientation and position of the image light exiting from the output waveguide 204 may be controlled by changing the orientation and position of the image light 219 entering the coupling element 218. The pitch of the diffraction grating may be in the range of 300 nm to 600 nm.

In particular embodiments, the output waveguide 204 may be composed of one or more materials that can facilitate total internal reflection of the image light 219. The output waveguide 204 may be composed of one or more materials including, for example, but not limited to, silicon, plastic, glass, polymers, or some combination thereof. The output waveguide 204 may have a relatively small form factor. As an example and not by way of limitation, the output waveguide 204 may be approximately 50 mm wide along X-dimension, 30 mm long along Y-dimension and 0.5-1 mm thick along Z-dimension. The controller 216 may control the scanning operations of the light source assembly 210. The controller 216 may determine scanning instructions for the light source assembly 210 based at least on the one or more display instructions for rendering one or more images. The display instructions may include an image file (e.g., bitmap) and may be received from, for example, a console or computer of the AR/VR system. Scanning instructions may be used by the light source assembly 210 to generate image light 219. The scanning instructions may include, for example, but are not limited to, an image light source type (e.g., monochromatic source, polychromatic source), a scanning rate, a scanning apparatus orientation, one or more illumination parameters, or some combination thereof. The controller 216 may include a combination of hardware, software, firmware, or any suitable components supporting the functionality of the controller 216.

FIG. 2B illustrates an example scanning operation of a scanning waveguide display 200B. The light source 220 may include an array of light emitters 222 (as represented by the dots in inset) with multiple rows and columns. The light 223 emitted by the light source 220 may include a set of collimated beams of light emitted by each column of light emitters 222. Before reaching the mirror 224, the light 223 may be conditioned by different optical devices such as the conditioning assembly (not shown). The mirror 224 may reflect and project the light 223 from the light source 220 to the image field 227 by rotating about an axis 225 during scanning operations. The mirror 224 may be a microelectromechanical system (MEMS) mirror or any other suitable mirror. As the mirror 224 rotates about the axis 225, the light 223 may be projected to a different part of the image field 227, as illustrated by the reflected part of the light 226A in solid lines and the reflected part of the light 226B in dash lines.

In particular embodiments, the image field 227 may receive the light 226A-B as the mirror 224 rotates about the axis 225 to project the light 226A-B in different directions. For example, the image field 227 may correspond to a portion of the coupling element 218 or a portion of the decoupling element 206 in FIG. 2A. In particular embodiments, the image field 227 may include a surface of the coupling element 206. The image formed on the image field 227 may be magnified as light travels through the output waveguide 220. In particular embodiments, the image field 227 may not include an actual physical structure but include an area to which the image light is projected to form the images. The image field 227 may also be referred to as a scan field. When the light 223 is projected to an area of the image field 227, the area of the image field 227 may be illuminated by the light 223. The image field 227 may include a matrix of pixel locations 229 (represented by the blocks in inset 228) with multiple rows and columns. The pixel location 229 may be spatially defined in the area of the image field 227 with a pixel location corresponding to a single pixel. In particular embodiments, the pixel locations 229 (or the pixels) in the image field 227 may not include individual physical pixel elements. Instead, the pixel locations 229 may be spatial areas that are defined within the image field 227 and divide the image field 227 into pixels. The sizes and locations of the pixel locations 229 may depend on the projection of the light 223 from the light source 220. For example, at a given rotation angle of the mirror 224, light beams emitted from the light source 220 may fall on an area of the image field 227. As such, the sizes and locations of pixel locations 229 of the image field 227 may be defined based on the location of each projected light beam. In particular embodiments, a pixel location 229 may be subdivided spatially into subpixels (not shown). For example, a pixel location 229 may include a red subpixel, a green subpixel, and a blue subpixel. The red, green and blue subpixels may correspond to respective locations at which one or more red, green and blue light beams are projected. In this case, the color of a pixel may be based on the temporal and/or spatial average of the pixel's subpixels.

In particular embodiments, the light emitters 222 may illuminate a portion of the image field 227 (e.g., a particular subset of multiple pixel locations 229 on the image field 227) with a particular rotation angle of the mirror 224. In particular embodiment, the light emitters 222 may be arranged and spaced such that a light beam from each of the light emitters 222 is projected on a corresponding pixel location 229. In particular embodiments, the light emitters 222 may include a number of light-emitting elements (e.g., micro-LEDs) to allow the light beams from a subset of the light emitters 222 to be projected to a same pixel location 229. In other words, a subset of multiple light emitters 222 may collectively illuminate a single pixel location 229 at a time. As an example and not by way of limitation, a group of light emitter including eight light-emitting elements may be arranged in a line to illuminate a single pixel location 229 with the mirror 224 at a given orientation angle.

In particular embodiments, the number of rows and columns of light emitters 222 of the light source 220 may or may not be the same as the number of rows and columns of the pixel locations 229 in the image field 227. In particular embodiments, the number of light emitters 222 in a row may be equal to the number of pixel locations 229 in a row of the image field 227 while the light emitters 222 may have fewer columns than the number of pixel locations 229 of the image field 227. In particular embodiments, the light source 220 may have the same number of columns of light emitters 222 as the number of columns of pixel locations 229 in the image field 227 but fewer rows. As an example and not by way of limitation, the light source 220 may have about 1280 columns of light emitters 222 which may be the same as the number of columns of pixel locations 229 of the image field 227, but only a handful rows of light emitters 222. The light source 220 may have a first length L1 measured from the first row to the last row of light emitters 222. The image field 530 may have a second length L2, measured from the first row (e.g., Row 1) to the last row (e.g., Row P) of the image field 227. The L2 may be greater than L1 (e.g., L2 is 50 to 10,000 times greater than L1).

In particular embodiments, the number of rows of pixel locations 229 may be larger than the number of rows of light emitters 222. The display device 200B may use the mirror 224 to project the light 223 to different rows of pixels at different time. As the mirror 520 rotates and the light 223 scans through the image field 227, an image may be formed on the image field 227. In some embodiments, the light source 220 may also has a smaller number of columns than the image field 227. The mirror 224 may rotate in two dimensions to fill the image field 227 with light, for example, using a raster-type scanning process to scan down the rows then moving to new columns in the image field 227. A complete cycle of rotation of the mirror 224 may be referred to as a scanning period which may be a predetermined cycle time during which the entire image field 227 is completely scanned. The scanning of the image field 227 may be determined and controlled by the mirror 224 with the light generation of the display device 200B being synchronized with the rotation of the mirror 224. As an example and not by way of limitation, the mirror 224 may start at an initial position projecting light to Row 1 of the image field 227, and rotate to the last position that projects light to Row P of the image field 227, and then rotate back to the initial position during one scanning period. An image (e.g., a frame) may be formed on the image field 227 per scanning period. The frame rate of the display device 200B may correspond to the number of scanning periods in a second. As the mirror 224 rotates, the light may scan through the image field to form images. The actual color value and light intensity or brightness of a given pixel location 229 may be a temporal sum of the color various light beams illuminating the pixel location during the scanning period. After completing a scanning period, the mirror 224 may revert back to the initial position to project light to the first few rows of the image field 227 with a new set of driving signals being fed to the light emitters 222. The same process may be repeated as the mirror 224 rotates in cycles to allow different frames of images to be formed in the scanning field 227.

FIG. 3A illustrates an example 2D micro-LED waveguide display 300A. In particular embodiments, the display 300A may include an elongate waveguide configuration 302 that may be wide or long enough to project images to both eyes of a user. The waveguide configuration 302 may include a decoupling area 304 covering both eyes of the user. In order to provide images to both eyes of the user through the waveguide configuration 302, multiple coupling areas 306A-B may be provided in a top surface of the waveguide configuration 302. The coupling areas 306A and 306B may include multiple coupling elements to receive image light from light emitter array sets 308A and 308B, respectively. Each of the emitter array sets 308A-B may include a number of monochromatic emitter arrays including, for example, but not limited to, a red emitter array, a green emitter array, and a blue emitter array. In particular embodiments, the emitter array sets 308A-B may further include a white emitter array or an emitter array emitting other colors or any combination of any multiple colors. In particular embodiments, the waveguide configuration 302 may have the emitter array sets 308A and 308B covering approximately identical portions of the decoupling area 304 as divided by the divider line 309A. In particular embodiments, the emitter array sets 308A and 308B may provide images to the waveguide of the waveguide configuration 302 asymmetrically as divided by the divider line 309B. For example, the emitter array set 308A may provide image to more than half of the decoupling area 304. In particular embodiments, the emitter array sets 308A and 308B may be arranged at opposite sides (e.g., 180° apart) of the waveguide configuration 302 as shown in FIG. 3B. In other embodiments, the emitter array sets 308A and 308B may be arranged at any suitable angles. The waveguide configuration 302 may be planar or may have a curved cross-sectional shape to better fit to the face/head of a user.

FIG. 3B illustrates an example waveguide configuration 300B for the 2D micro-LED waveguide display. In particular embodiments, the waveguide configuration 300B may include a projector device 350 coupled to a waveguide 342. The projector device 320 may include a number of light emitters 352 (e.g., monochromatic emitters) secured to a support structure 354 (e.g., a printed circuit board or other suitable support structure). The waveguide 342 may be separated from the projector device 350 by an air gap having a distance of D1 (e.g., approximately 50 μm to approximately 500 μm). The monochromatic images projected by the projector device 350 may pass through the air gap toward the waveguide 342. The waveguide 342 may be formed from a glass or plastic material. The waveguide 342 may include a coupling area 330 including a number of coupling elements 334A-C for receiving the emitted light from the projector device 350. The waveguide 342 may include a decoupling area with a number of decoupling elements 336A on the top surface 318A and a number of decoupling elements 336B on the bottom surface 318B. The area within the waveguide 342 in between the decoupling elements 336A and 336B may be referred as a propagation area 310, in which image light received from the projector device 350 and coupled into the waveguide 342 by the coupling element 334 may propagate laterally within the waveguide 342.

The coupling area 330 may include coupling elements (e.g., 334A, 334B, 334C) configured and dimensioned to couple light of predetermined wavelengths (e.g., red, green, blue). When a white light emitter array is included in the projector device 350, the portion of the white light that falls in the predetermined wavelengths may be coupled by each of the coupling elements 334A-C. In particular embodiments, the coupling elements 334A-B may be gratings (e.g., Bragg gratings) dimensioned to couple a predetermined wavelength of light. In particular embodiments, the gratings of each coupling element may exhibit a separation distance between gratings associated with the predetermined wavelength of light and each coupling element may have different grating separation distances. Accordingly, each coupling element (e.g., 334A-C) may couple a limited portion of the white light from the white light emitter array of the projector device 350 if white light emitter array is included in the projector device 350. In particular embodiments, each coupling element (e.g., 334A-C) may have the same grating separation distance. In particular embodiments, the coupling elements 334A-C may be or include a multiplexed coupler.

As illustrated in FIG. 3B, a red image 320A, a blue image 320B, and a green image 320C may be coupled by the coupling elements 334A, 334B, 334C, respectively, into the propagation area 310 and may begin to traverse laterally within the waveguide 342. A portion of the light may be projected out of the waveguide 342 after the light contacts the decoupling element 336A for one-dimensional pupil replication, and after the light contacts both the decoupling elements 336A and 336B for two-dimensional pupil replication. In two-dimensional pupil replication, the light may be projected out of the waveguide 342 at locations where the pattern of the decoupling element 336A intersects the pattern of the decoupling element 336B. The portion of the light that is not projected out of the waveguide 342 by the decoupling element 336A may be reflected off the decoupling element 336B. The decoupling element 336B may reflect all incident light back toward the decoupling element 336A. Accordingly, the waveguide 342 may combine the red image 320A, the blue image 320B, and the green image 320C into a polychromatic image instance which may be referred as a pupil replication 322. The polychromatic pupil replication 322 may be projected to the user's eyes which may interpret the pupil replication 322 as a full color image (e.g., an image including colors addition to red, green, and blue). The waveguide 342 may produce tens or hundreds of pupil replication 322 or may produce a single replication 322.

In particular embodiments, the AR/VR system may use scanning waveguide displays or 2D micro-LED displays for displaying AR/VR content to users. In order to miniaturize the AR/VR system, the display system may need to miniaturize the space for pixel circuits and may have limited number of available bits for the display. The number of available bits in a display may limit the display's color depth or gray scale level, and consequently limit the quality of the displayed images. Furthermore, the waveguide displays used for AR/VR systems may have nonuniformity problem cross all display pixels. The compensation operations for pixel nonuniformity may result in loss on image grayscale and further reduce the quality of the displayed images. For example, a waveguide display with 8-bit pixels (i.e., 256 gray level) may equivalently have 6-bit pixels (i.e., 64 gray level) after compensation of the nonuniformity (e.g., 8:1 waveguide nonuniformity, 0.1% dead micro-LED pixel, and 20% micro-LED intensity nonuniformity).

AR/VR display systems may use pupil-replication waveguides to transmit image light to a viewer's eyes. However, the waveguides may have spatially-varying non-uniformity for light transmission of each of RGB color channels. This non-uniformity may cause displayed images to have different colors when viewed from different eye positions, and therefore negatively affect user experience. Ideally, a static image viewed from a particular eye position may have its pixel values adjusted to compensate to the waveguide non-uniformity and eliminate the negative visual effect. However, for a sequence of dynamical images viewed from different eye positions, an eye tracking system may be needed to measure the eye position of the viewer dynamically to determine the appropriate compensation. The eye tracking system for determining the eye positions may have some problems, such as, latency and limitations in accuracy and precision. If the images are directly corrected based on eye positions provided by the eye tracking system, which could be inaccurate or delayed, the corrections made to the images could be in accurate or incorrect. When this happens, the viewer may observe flicker artifacts in the displayed sequence of images.

To solve this problem, particular embodiments of the system may correct the images to be displayed using correction maps that are generated based on: (1) the current eye position as determined using the eye tracking system; and (2) a temporal filter and previous correction maps used for correcting preceding frames. The system may generate correction maps for a number of pre-determined eye positions. Each correction map may include an array of scaling factors to scale the image pixel values. The system may store the pre-generated correction maps in a computer storage. For correcting a current frame of a sequence of images, the system may first determine the current eye position of the viewer using the eye tracking system and determine the correction maps for the current eye position based on interpolation (e.g., bicubic interpolation) of the correction maps retrieved from the computer storage. Then, the system may use a temporal filter to generate optimized correction maps based on the correction map generated by interpolation based on the current eye position and the correction maps used for correcting the preceding frames. After that, the system may up-sample the averaged correction maps into a higher spatial resolution that matches the image resolution or display resolution and apply the high-resolution maps to the current frame for display. As a result, the visual artifacts in the displayed sequence of images caused by the waveguide non-uniformity may be eliminated or reduced.

By compensating the waveguide non-uniformity, particular embodiments of the system may generate and display more realistic images with more accurate and precise colors. By using correction maps generated based on current eye positions, particular embodiments of the system may effectively eliminate or reduce the color change artifacts caused by the non-uniformity of the waveguide while the user's eye are moving with respect to the waveguide. The displayed content may appear to be smoother over time and more resilient to errors in the eye-tracking data. By using a temporal filter and taking into consideration correction maps of preceding frames, particular embodiments of the system may effectively eliminate or reduce the flicker artifacts caused by the non-uniformity compensation that only considers the spatial non-uniformity without considering the temporal domain. By generating and storing pre-determined correction maps with limited resolutions and at limited number of pre-determined eye positions, the system may improve the system efficiency and reduce the usage of computer resources.

In particular embodiments, the AR/VR display systems may use pupil-replication waveguides to transmit light to a viewer's eyes for display images or videos to the viewer. The images coupled into the waveguides may be replicated over the field of view. The pupil-replication waveguides may have spatially-varying properties for transmitting light of different colors and intensity nonuniformity for RGB color channels. As a result, a displayed image (or a portion of the displayed image) may appear to have different colors when being viewed from different eye positions (also referred to as pupil positions). For example, when an image is viewed from a particular eye position, an image region that should be white may appear to be magenta because the transmission of green channel is suppressed by the waveguides when viewed from that particular eye position. In particular embodiments, the system may compensate the waveguide's non-uniformity by adjusting the pixel values of the displayed images based on the current eye positions of the viewer. As an example and not by way of limitation, the system may measure the light transmission characteristics of the waveguides for particular eye positions and generate correction maps based on the measured transmission characteristics of the waveguides for those particular eye positions. Each correction map include an array of scaling factors for scaling image pixel values of a particular color channel. The system may generate a correction map for each color channel of the RGB color channels. When the viewer's eyes are at those particular eye positions, the system may apply the correction maps on the images to be displayed to adjust the pixel values of these images. An image with adjusted pixel values once displayed may have correct colors when viewed from those particular eye positions with the waveguide non-uniformity effect being eliminated or reduced.

Assuming that the desired full-color image in linear space is characterized by a first matrix P and the color waveguide pattern is characterized by a second matrix W, then the image I as seen by the viewer may be expressed as the following equation:

I=P·W (1)

The system may compensate the waveguide nonuniformity to reverse the color distortions in the images by modifying the pixel values of the image using correction maps F as determined by the following equation:

F=W⁻¹ (2)

Then, the system may generate a reasonable approximation to the desired image by applying the correction maps and deriving a corrected image P′ in linear space using the following equation:

P′=P·F (3)

where the values in F may be in the range of [0, 1]. The image as seen by the viewer may be characterized by the following equation:

I=P′·W=(P·F)·W≈P (4)

The approximation may be due to imperfect correction arising from factors such as latency and limited precision and accuracy in eye position measurement, misalignments, eye movements, etc. The correction range may be contained within the value range of F. In particular embodiments, the non-uniformity level may be within a nominal level of 5:1 and the ratio of the maximum F value to the minimum F value may be equal to or less than 5.

In particular embodiments, for a static image to be viewed from a particular eye position, the system may compensate the waveguide non-uniformity by applying the corresponding correction maps to that image to adjust its pixel values. And, the image with adjusted pixel values once displayed, when being viewed from that particular eye position, may have no or less visual artifacts caused by the waveguide non-uniformity. However, for displaying a sequence of dynamical images to a viewer and when the viewer's eye positions move within the field of view (e.g., from left to right), the sequence of dynamical images may appear to have different colors when viewed from different eye positions. As a result, the waveguide non-uniformity that varies with eye positions may impose both spatial and temporal requirements on the images to be displayed. Unlike the static image which can be effectively compensated in spatial-domain (e.g., using the correction maps for particular eye positions), a sequence of dynamical images to be viewed from different eye positions may need to be compensated in both spatial and temporal domains. In particular embodiments, for displaying a sequence of dynamical images viewed from different eye positions, the system may use an eye tracking system to measure the eye positions of the viewer dynamically and determine corresponding correction maps based on the dynamically measured eye positions.

However, the eye tracking system may have latency problem for measuring the eye positions for dynamical non-uniformity correction. The viewer's eyes may move by a relatively large distance during the time for generating and applying correction maps that are associated with a particular eye position. The viewer's eyes positions as determined by the eye tracking system may fall behind in time with respect to the actual eye positions of the viewer. The system may have a constant or variable time period between a first time moment when the eye tracking system measures the eye positions and a second time moment when the corrected frame is actually rendered and displayed. In particular embodiments, the latency of the eye tracking system may be up to 7 ms. Furthermore, the eye tracking system may have limited accuracy (e.g., a constant spatial offset from the ground truth) and limited precision (e.g., a sample-to-sample jitter, a time-varying difference between the ground truth and the eye tracking reading) for measuring the eye positions. In particular embodiments, the precision of the eye tracking system may be 0.086 mm (corresponding to 0.5 degree of the view angle) and the accuracy of the eye tracking system may be 0.125 mm (corresponding to 0.7 degree of the view angle). The accuracy and the precision of the eye tracking system may be independent to each other but may have joint impact on the quality of the displayed images. Spatial artifacts may be affected by the accuracy of the eye tracking system. Temporal artifacts may be affected by both accuracy and precision of the eye tracking system. As a result, if the images are directly corrected based on eye positions provided by the eye tracking system, the compensation made to the images may be inaccurate and non-precise. When this happens, the viewer may observe flicking or flashing artifacts in the displayed images. For example, a constant bias in the eye tracking system reading on the eye positions may result in inaccurate compensation maps. In-precise eye position reading may lead to a higher level of noise in the eye position data and cause the correction maps to be non-smooth in temporal domain (e.g., the difference in correction maps of sequential frames being above a threshold). To solve these problems, particular embodiments of the system may correct the images to be displayed based on correction maps generated based on: (1) the current eye position (as determined using the eye tracking system); and (2) a temporal filter taking into consideration correction maps used for correcting previously frames, as will be described in later sections of this disclosure.

AR/VR systems may use waveguides to transmit the emitted light by LEDs to the pupils of the human eyes. The waveguide may receive the light corresponding to a whole frame of image from the display LEDs and transmit the light to the human eyes. For example, the system may use optical fibers as waveguides for displaying images to users. To address the limitation of waveguides, an originally rectangular viewport may have cutout-corners and may have an octagonal shape in the field of view, which may lead to a non-optimal visual experience to users. To address this problem, the system may use the per-pixel correction provided by the non-uniformity correction (NUC) mechanism to blur the edges of the viewport based on the particular waveguide characteristics of each headset. The system may determine, based on the waveguide characteristics of the viewport, a scaling factor for each pixel value in the image to be displayed. The scaling factors, once applied to the pixel values of the image, may create a fade-away effect on the edges and corners of the image by modifying the pixel values in the image. As a result, the display image may have a reduced brightness level in the areas close to the edges of the view port. And, the viewport appearance may be blurred in the areas close to its edges or corners and the octagonal visual effect of viewport may be smoothed, leading to a more optimal visual experience for users. The system may adaptively compute the blurring coefficients based on on-device evaluations of LED wear-out and may combine the blurring coefficients with the scaling factor matrix for non-uniformity correction. As a result, the system may adjust the pixel values of the images for creating the fade-away effect during the non-uniformity correction process.

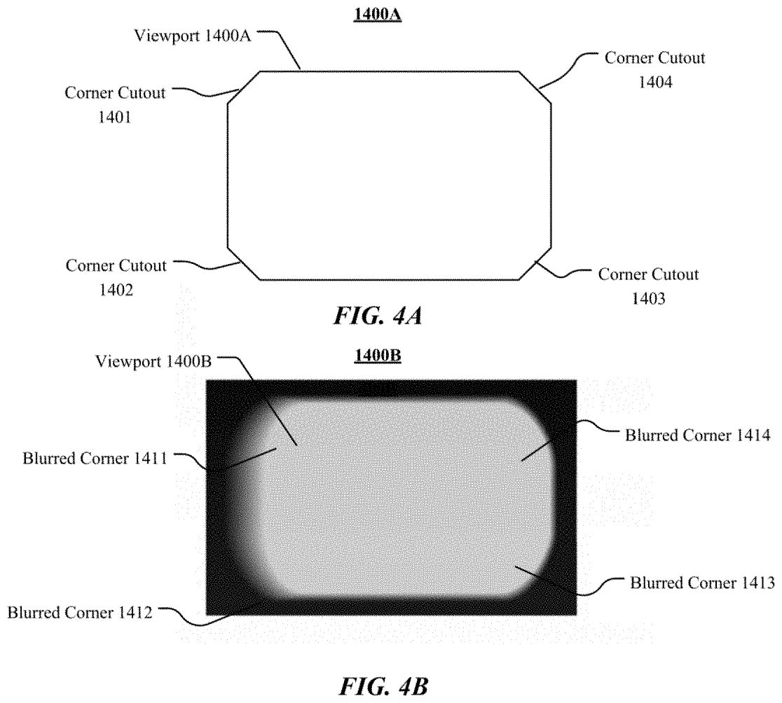

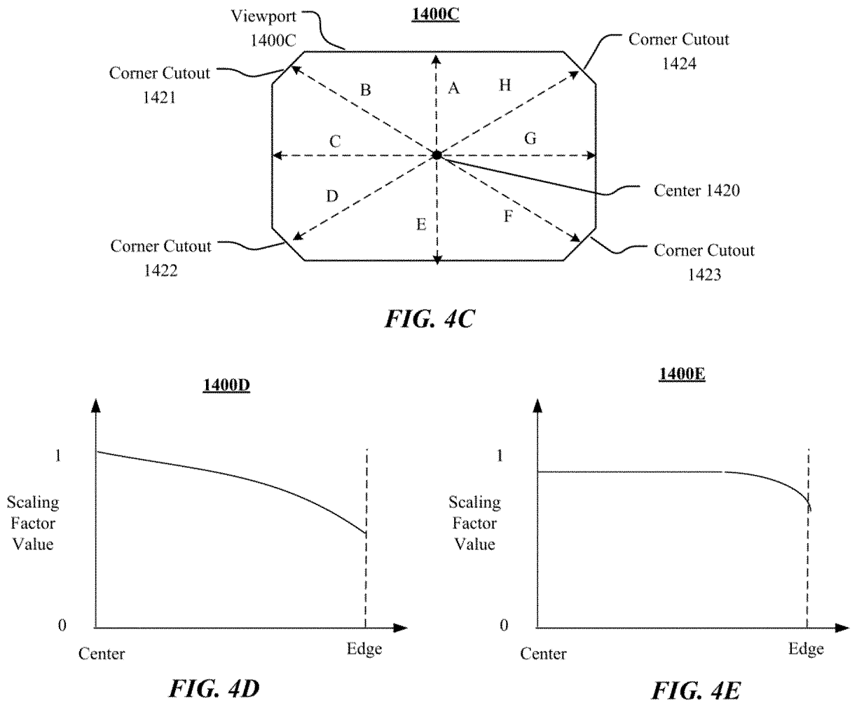

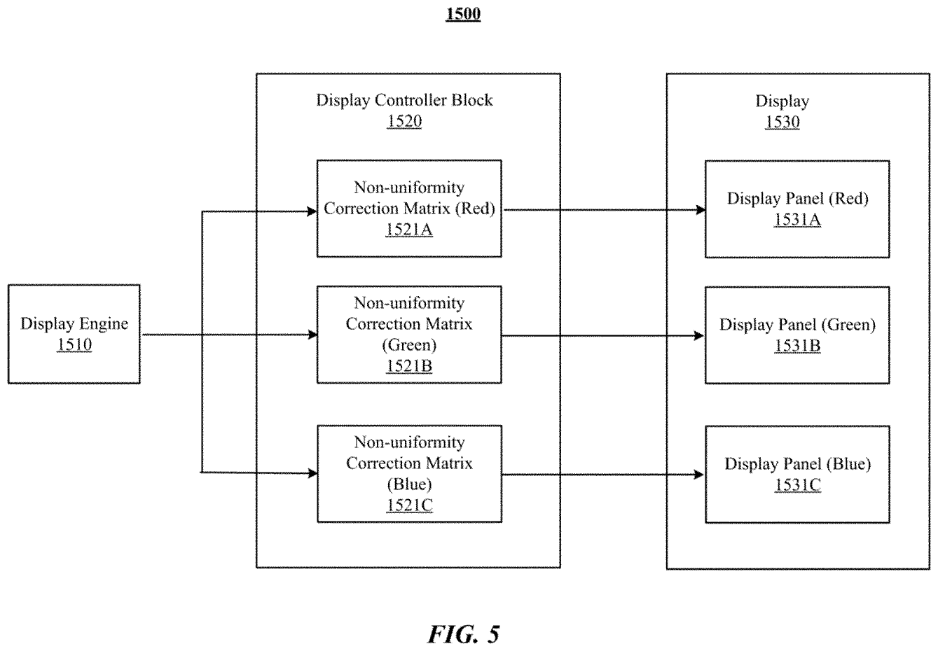

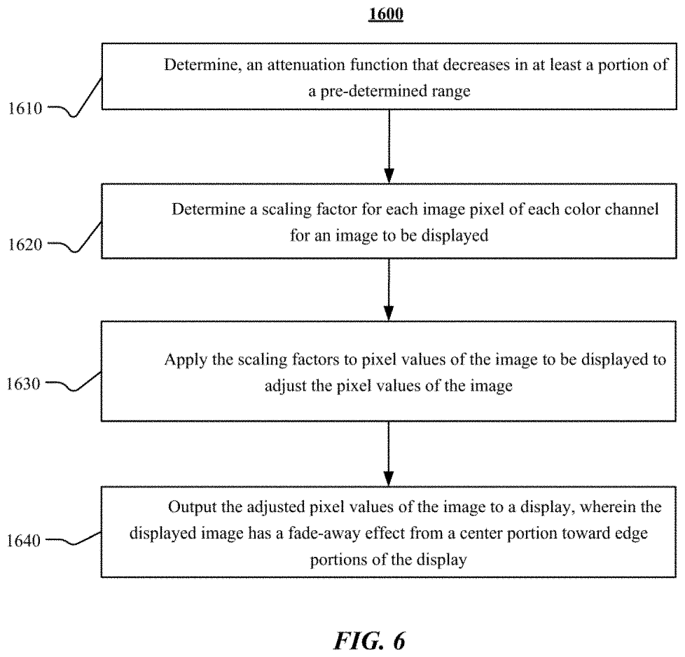

FIG. 4A illustrates an example viewport 1400A having corner cutouts. In particular embodiments, the system may use waveguide for display. To mitigate the waveguide artifacts, the view port of the waveguide may be octagonal shape. For example, the view port shape may be based on a rectangular shape with corner cutouts (e.g., 1401, 1402, 1403, 1404). As a result, the corner cutouts may create less optimal visual experience to users by creating an octagonal field of view to users, which can be unnatural to most users. Visually, the cropped corners of the viewport may be improved by creating a fade-away effect that can smooth the edges of the view port to create more optimal visual experience. To achieve this, the system may use a per-pixel correction to gradually decrease the brightness of the pixels towards the corners of the viewport. However, the per-pixel correction, if implemented separately, may require extra memory space and computational resources. To address this concern, in particular embodiments, the system may combine the per-pixel correction for fade-away effect into the non-uniformity correction (NUC) matrix. The system may use the firmware level operations to modify the NUC coefficients on a per-pixel per-color-component basis. Once the modified NUC matrix is applied to the images to be displayed, the system may achieve the fade-away effect during the NUC operations without using extra memory or computational resources.

FIG. 4B illustrates an example view port 1400B with the fade-away effect. As shown in FIG. 4B, the fade-away effect on the edges of the view port 1400B may create the blurred corner shapes (e.g., 1411, 1412, 1413, 1414) and may generate a smooth transition from the center display area to the edges of the view port 1410. As a result, the overall visual effect may be much smoother, leading to more optimal user experiences.

FIG. 4C illustrates an example scheme 1400C for design the attenuation function to create the fade-away effect. In particular embodiments, the system may generate a fade-away effect along one or more directions from the center of the view port to the edges and corners of the view port (e.g., directions selected from the directions of A, B, C, D, E, F, G, H). Along each direction selected, the system may generate an attenuation function that monotonously decrease from the center point to the edges. Then, the system may use these attenuation function to determine the scaling factor values. In particular embodiments, the system may use the same attenuation function for the opposite direction along the same line (e.g., A-E, B-F, C-G, D-H) to generate a symmetric fade-away effect with respect to the center point 1420 of the view port 1400C. In particular embodiments, the system may generate the fade-away effect along only a subset of directions as shown in FIG. 4C. For example, the system may generate the fade-away effect along the C-G direction. As another example, the system may generate the fade-away effect along the direction of B-F and D-H. As another example, the system may generate a fade-away effect along more directions as shown in FIG. 4C. In particular embodiments, instead of generating a fade-away effect along only selected number of directions, the system may use a 2D continuous attenuation function, which peaks at the center point 420 and monotonously decreases along any directions from the center point 1420 to any edges.

FIGS. 4D and 4E illustrate example attenuation functions 1400D and 1400E for creating the fade-away effect. In particular embodiments, the system may first determine the waveguide characteristics of each color channel of RGB color channels. For example, the waveguide of each color channel may have different appearance in shapes because of the transmission characteristics for the particular color of light. The system may determine the attenuation function and the scaling factors for the waveguide of each color channel based on the characteristics of the waveguide of that color channel. The attenuation function and corresponding scaling factor values may be different for the waveguides of different color channels because the waveguides may have different transmission properties for transmitting light of different colors. The system may use a model to convert the waveguide characteristics and transmission properties of particular color channels to the attenuation functions and the scaling factor values.

As an example, using the attenuation function as shown in FIG. 4D, the scaling factor value for the center point 1420 may equal to 1, which means the brightness of the pixel at center will not be dimmed once the correction is applied. The attenuation function may peak at the center point and monotonously decreases decrease toward the edge of the view port. The system may determine the corresponding scaling factors based on this attenuation function and incorporate these scaling factors into the NUC matrix, which once applied to the image pixel values, will correction the non-uniformity and generate the fade-away effect at the same time. As another example, using the attenuation function as shown in FIG. 4E, the scaling factors for the center area of the view port may equal to 1, which means the brightness level of the corresponding pixels in the center area will not be dimmed by the fade-away effect coefficients. The scaling factors may decrease monotonously in the edge areas of the view port along the directions toward the edges. The system may determine the corresponding scaling factors based on this attenuation function and incorporate these scaling factors into the NUC matrix, which once applied to the image pixel values, will correction the non-uniformity and generate the fade-away effect at the same time. As a result, the system may create the fade-away effect by adjusting the pixel values only in the edge areas of the view port.

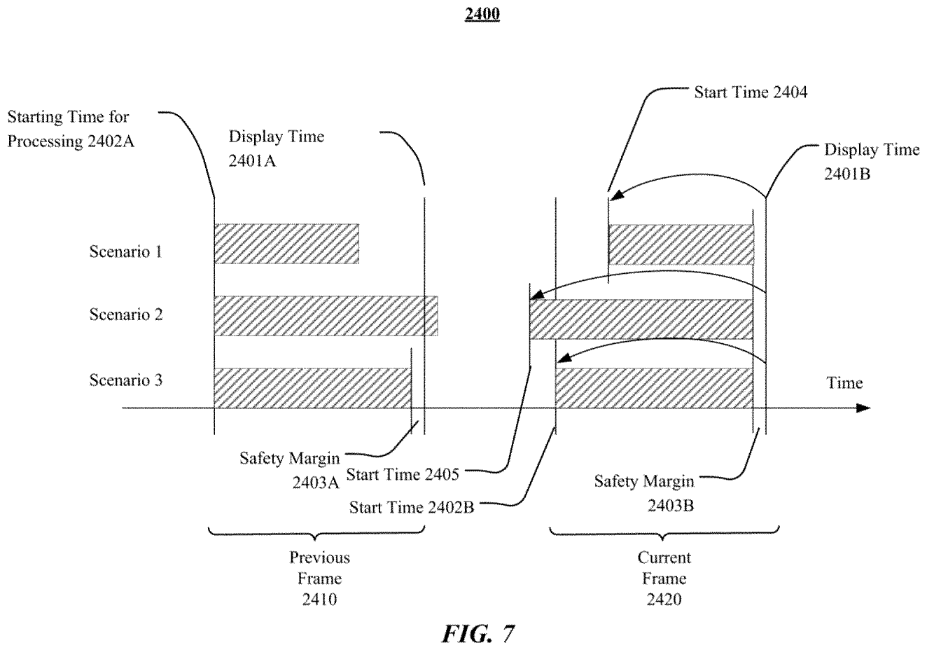

FIG. 5 illustrates an example framework 1500 for creating a fade-away effect for an octagonal view port. In particular embodiments, the system may use a display engine 1510 to generate the NUC matrix and the fade-away effect coefficients. The display 13530 may include three display panels corresponding to the three color channels of RGB. In particular embodiments, the system may determine a scaling factor for each color channel of RGB of each image pixel value in the image to be displayed. As a result, the system may generate three matrixes of scaling factors for the image pixel values corresponding to the three color channel of RGB. The system may incorporate these scaling factor matrixes into the NUC matrixes of RGB color channel, respectively. The NUC matrixes for the non-uniformity corrections may be for the entire screen. For example, the system may determine a first scaling factor matrix for the Red color channel and incorporate the matrix into the NUC matrix 1521A for the Red color channel. The system may determine a second scaling factor matrix for the Green color channel and incorporate the matrix into the NUC matrix 1521B for the Green color channel. The system may determine a second scaling factor matrix for the blue color channel and incorporate the matrix into the NUC matrix 1521C for the Blue color channel. The system NUC matrixes that are modified by the scaling factors may be stored in the memory unit for the NUC matrixes in the display control block 1520. At run time, the system may apply these NUC matrixes that have incorporated the scaling factors to the pixel values of the image to be displayed. Then, the system may output the pixel values of the RGB color channels as modified by the scaling factors in the NUC matrixes to the three display panels of RGB color channels, respectively. As a result, the system may correct the display non-uniformity and generate a fade-away effect for the display view port in the same correction process and using the same matrixes (without using extra memory storage space or extra computational resources).

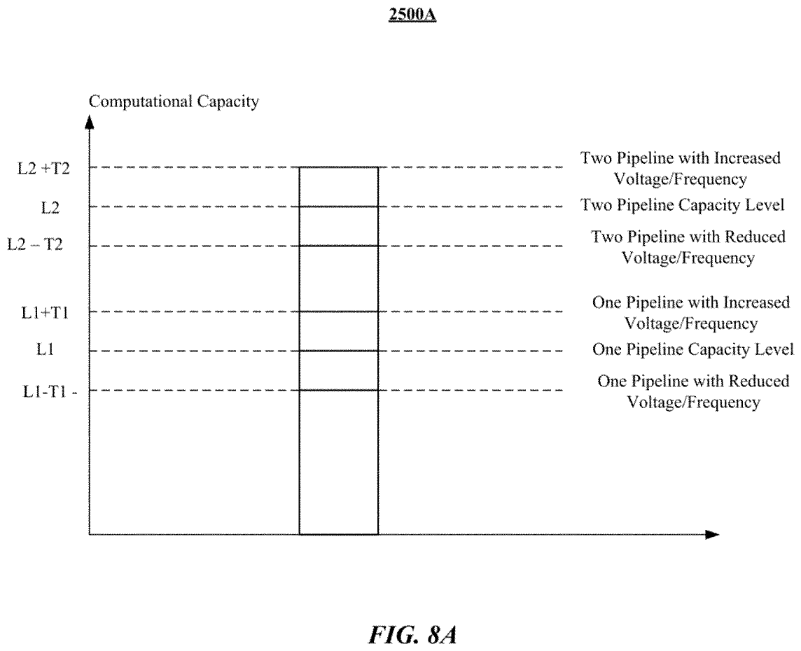

FIG. 6 illustrates an example method 1600 for generating a fade-away effect for a view port of a display. The method may begin at step 1610, where a computing system may determine, an attenuation function that decreases in at least a portion of a pre-determined range. At step 1620, the system may determine a scaling factor for each image pixel of each color channel for an image to be displayed. At step 1630, the system may apply the scaling factors to pixel values of the image to be displayed to adjust the pixel values of the image. At step 1640, the system may output the adjusted pixel values of the image to a display. The displayed image may have a fade-away effect from a center portion toward edge portions of the display. In particular embodiments, the scaling factors for RGB color channels may be incorporated into respective non-uniformity correction matrixes of RGB color channels. In particular embodiments, the display may be associated with an octagonal view port. The octagonal view port may have smoothed edge areas with the fade-away effect. In particular embodiments, to generate the fade-away effect at edges of the view port, the system may use the per-pixel correction provided by the non-uniformity correction (NUC) mechanism. The system may use octagonal cutout to address the limitations of waveguides and use the NUC mechanism to blur the edges of the viewport based on the particular waveguide characteristics of each headset. The system may adaptively compute the blurring coefficients based on on-device evaluations of LED wear-out. The attenuation function and the scaling factors may be based on one or more characteristics of an associated waveguide for that color channel.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for generating a fade-away effect for a view port of a display including the particular steps of the method of FIG. 6, this disclosure contemplates any suitable method for generating a fade-away effect for a view port of a display including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Adaptive Resource Allocation Based On Dynamic Workload

Particular embodiments described herein relate to systems and methods of adaptively increase or decrease display engine's resources based on a feedback loop depending on the current rendering workload of the headset. By looking at display engine's performance in the previous frame(s), the system may determine whether more resources are needed to handle the current workload. For example, if display engine could not render a full-frame within the display's refresh rate (e.g., due to a sudden increase in the number of surfaces to render), an additional processing pipeline in the display engine may be enabled to help render the content in parallel. Workload may also be adjusted based on voltage and frequency scaling or foveated rendering. For example, when the system determines that the workload will be slightly over the capacity of one single pipeline but is way below the capacity of two pipelines, the system may increase the voltage or/and frequency of the processing unit of the currently operative pipeline to increase the computational capacity, rather than turning on the second pipeline that consume more power and lead to waste in the computational capacity. As another example, when the system determine that the predicted workload is above the threshold level that can be handled by one single pipeline, even with increased voltage or/and frequency, the system may then turn on the second pipeline to increase the computational capacity at the cost of more power consumption. As another example, when the system determines that the predicted workload for the current frame is above the capacity of two pipeline combined, the system may determine that even with two pipeline being turned on, the rendering process will encounter some delay and the frame may not able to be rendered at the current frame rate. Then, the system may adjust the foveation ratio of the display by reducing the region size of the high resolution region and increase the region size for the low-resolution to reduce the size of the workload to a level that is within the limits of the two pipelines. As a result, the system may generate the current fame at the target frame rate and the render process may cause no delays in generating the current frame.

To keep a target frame rate, the system may need to generate the display content (e.g., the current frame to be displayed) before the scheduled display time (e.g., 401A, 402B) with the safe margin time (e.g., 403A). The system may estimate the amount of time that is needed for processing data and generate the current frame based on the content of frame data. Then, the system schedule the rendering process accordingly so that the frame can be generated before the scheduled display time as determined by the target framerate. However, the estimation may not be accurate sometimes. When the system needs more time than the scheduled time period to generate the current frame, the current frame may not be completed before the scheduled display time and that may cause delay in displaying the current frame with a reduced frame rate or cause the incomplete frame to be displayed. To solve this problem, the system may track the workload of the processing units in the display engine for generating one or more previous frames and use the workload of the previous frame(s) to estimate the workload of the current frame, taking into consideration the safety margin time and the display content.

In particular embodiments, the system may use eye tracking and inertial sensor data to track and predict the user's eye position and movement and use the predicted eye position for waveguide correction. The system may need to render the current frame as late as possible with respect to the scheduled display time, and ideally, complete the rendering of the current frame right before its scheduled display time, because that would allow the system to use the most recent sensor data and reduce the eye position estimation errors. Using the eye tracking data, the system can predict the eye position ahead into the future. However, the longer the prediction time, the higher the error the system would likely encounter. The system may estimate how long it takes for the system to render a frame because that amount of time may determine whether the current frame will encounter some delay or to be able to catch the target frame. For AR/VR systems, the less time it takes for rendering the current frame, the better display quality the system may get. For example, a simple message window may be generated and display by the system quickly within a short period of time. And, the system may keep the target frame. However, for a 3D avatar, the system may take longer time to render it and may not able to complete it begore the scheduled display time according the target frame rate. In general, the more complex the content, the longer time, the system would most likely need to render it.

In particular embodiments, the time when the system should begin to process the frame may be variable. The system may need to be set the time earlier on because it is time relative to the display time of the frame (i.e., the amount of the time prior the display time of the frame plus a safety margin period). The system may first determine the actual display time of a frame based on the target frame rate. Then, the system may schedule the processing time before that according to the amount of computation that is needed to process the content to be rendered. For example, if the computational amount is large, the system may schedule the processing earlier. If the computational amount is less, the system may schedule the processing later. Thus, the start time for generating a frame may be a flexible based on the amount of computation expected for generating that frame.

Estimating how complex the computation may be a challenging task. The system may not know definitely before the frame is completed. So, when the system render a frame, it may make a rough estimation on how complex the task and also how much time it needs to generate it before the display time. Then, the system may schedule the rendering process based on the estimated amount of time plus a pre-determined safety margin. If the system does not keep a safety margin for unexpected latency, the system may risk of delay if the frame is not completed during the scheduled time period. To reduce such risk, the system may need a large margin and allocate a longer period of time to guarantee the frame will be completed before its display time. However, the system may always have large latency, which may result in a low display quality, because of the larger margin and the longer period of time needed for generating the frames.

To solve this problem, in particular embodiments, the system may use two or more pipelines (i.e., two or more processing units) to process the data for rendering the display content. For example, the system may use two parallel processing units which may work parallelly with respect to each other to render the display content. The system may be more energy efficient to only use one unit when only one unit is needed. The system may generally run one of these units to reduce the power consumption. In particular embodiments, when the system turns on the second unit, the system may have a 70% increase in the performance and computational capacity at the cost of more power consumption. The system may complete the rendering a current frame with as short as possible margin time before the display time, so that the display frames are based on the most up-to-date sensor data and provide optimal display quality. If the rendering task is within the computational capacity of a single processing unit (considering the time period allocated for the rendering process), the system may render the frame just by using one single unit. The system may make an estimation on the computation amount and whether it can complete the workload. When the system decides that it cannot process the frame within the allocated time, the system may turn on the second pipeline to process the frame, to avoid delay.

In particular embodiments, the system may use a performance module to measure the amount of time that is used for generating previous frames and use that information in a feedback or feedforward loop to estimate the amount time that is needed for generating the current frame. Without that estimation, the system may not know what the performance margin for the current frame that the system is about to render. The system may use past frame performance by tracking how the workload changes from the previous frame to the current frame. When the workload increases significantly from the previous frame, the system may turn on the second pipeline to have more computational capacity. When the workload reduces significantly from the previous frame, the system may turn off the second pipeline to reduce the power consumption.

In particular embodiments, when the system starts to render a frame, the system may first use a firmware to set up the hardware pipeline. Then, the system may use the firmware to perform this estimation. The system may have put the bounding box in the surfaces of each frame. The system may determine the sizes of the bounding boxes and the number of bounding boxes. The system may estimate the amount of workload based on the sizes, the number of bounding boxes, and the number of surfaces. A surface may be a representation for one or more objects in the scene that move together. Some surfaces may have inclusion or overlaps on other surfaces. In particular embodiments, the system may not need to process that surface they don't overlap with other surfaces. The system may use the surface overlap to estimate the size of the workload. The system may use the texture ratios for the workload estimation. The system may monitor the previous frame for bandwidth and determine whether the bandwidth will likely increase or decrease on the pixel/textual ratio. The number of the surfaces may be another factor that can be used by the system to estimate the amount of time needed for rendering the current or next frame. The system may also use some other factors including, but limited to, transparency of surfaces, dynamic rendering, or any properties of the content that can affect the workload as a factor. Some factors may affect the bandwidth because they affect the compression related computation.

In particular embodiments, the system may use one previous frame (e.g., the last frame) to estimate the workload for the current frame. In particular embodiments, the system may use multiple previous frames to estimate the workload of the current frame. The system may track the trends of the workload of a serios of pervious frames and determine a predicted workload based on these trends. For example, the system may use a curve-fitting method to determine a trend function of the workload based on the previous frames and may predict the workload of the current frame based on the curve-fitting results. In addition, the system may consider other factors including, for example, the number of surfaces, the bounding box sizes of surfaces, the 3D or 2D characteristics of the objects in the scene, the texture, the transparency, etc.

In particular embodiments, when the second processing unit is turned on, it may run parallelly to the first unit to handle the same rending task. Also, the second unit may be adjusted based on the voltage and frequency scaling, or foveated rendering. The system may predict the workload, and determine, for example, this workload is too high for the current voltage and frequency that the processing unit(s) is/are operating. The system may increase the voltage and frequency a little bit for the processing unit(s) and that would provide more computational capacity than using the relatively lower voltage and frequency. By increasing the voltage and frequency under which the processing units operate, the system may have more computational capacity at the cost of a higher consumption. However, the amount of extra computational capacity that can be obtained by the increasing the voltage and frequency may be up to a limit and when the workload is above that limit, the system may need to turn on the second or more processing unit to handle it.

In particular embodiments, the system may use foveated rendering for displaying content with higher resolution in the region that encloses the user's gazing point and with lower resolution in the regions that are farer from the user's gazing point. With foveated rendering, instead of processing the frame with the full resolution, the system may process part of the image at lower resolutions. Areas that the user is not actively looking at may be processed with lower resolution. Even with some blur on the screen, it may not matter because the user is not focus on that region. When the workload is too high to be handled, the system may increase the ratio of the foveated rendering to reduce the workload. On the other hand, when the system has less workload and plenty computational capacity by the operating processing unit(s), the system may reduce the ratio for the foveated rendering, resulting in higher display quality. As discussed above, voltage and frequency scaling may another way to address the workload issue. The system may adjust the system to have more computational power when facing higher amount of workload by increasing the voltage and frequency under which the process unit(s) is/are operating. On the other hand, the system may reduce the power consumption when the system faces a lower amount of workload by decreasing the operative voltage and frequency. In particular embodiments, the system may combine all the methods that are discussed in this disclosure to dynamically determine whether to (1) turn on additional processing unit; (2) adjust operating voltage and frequency; or (3) adjust foveated rendering ratio, based on the estimated workload of the current frame. For example, when the workload is slightly above the capacity of the first processing unit, the system may increase the voltage and frequency a little bit without turning on the second unit or pipeline. When the workload significantly exceeded the capacity of the first processing unit, the system may turn on the second unit to handle that. The frequency and computational power may be linearly related. When the workload exceeded the capacity of the processing units even with the additional processing unit being turned on, the system may increase the ratio for the foveated rendering to reduce the workload. The system may use one or more methods or multiple methods as combined depending on the particular conditions of the system.

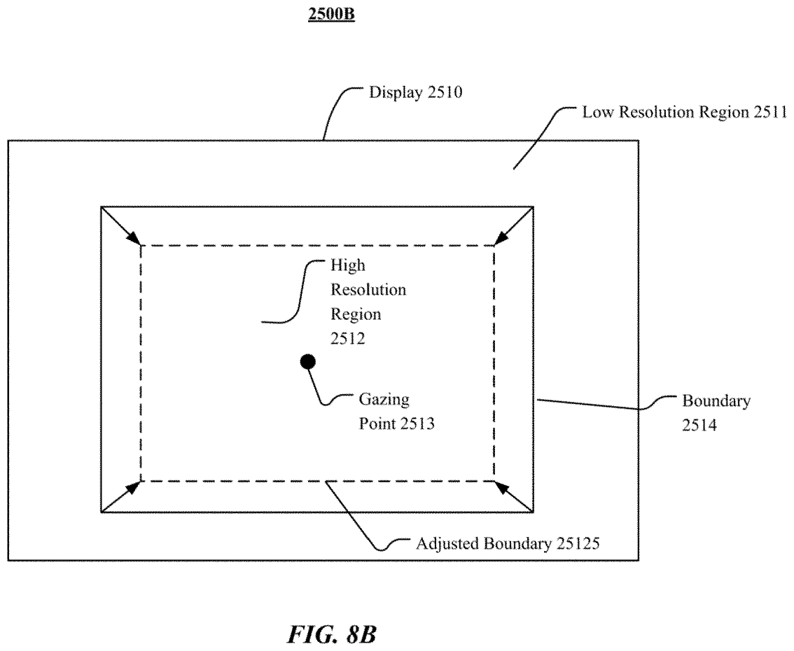

FIG. 7 illustrates example processes 2400 for determining workload for generating the current frame based on the workload of previous frames. As an example and not by way of limitation, for the scenario 1, the processing process of the previous frame 2410 may start at the start time 2402A and may be completed before the display time 2401A. The system may determine that the previous frame 2410 in scenario 1 has been completed head of the display time, indicating that the previous frame 2401 in scenario 1 needs a shorter time as scheduled by the system. Assuming the current frame 2420 is similar in complexity to the previous frame 2410, the system may estimate that the time needed for rendering the current frame 2420 is approximately the same to the time needed for rendering the previously frame 2410. Thus, the system may first determine the display time 2401B for the current frame 2410 based on the target frame rate. Then, the system may determine the start time 2404 based on the processing time duration of the previous frame 2410 and safety margin 2403B. Comparing to the previously frame 2410, the system may start to process the current frame 2420 at a later time 2404, allowing the current frame 2420 to be generated right before the scheduled display time 2401B. This may allow the system to use more up-to-date sensor data and provide higher display quality.

As an example and not by way of limitation, for the scenario 2, the processing process of the previous frame 2410 may start at the start time 2402A and may be completed after the display time 2401A. The system may determine that the previous frame 2410 in scenario 1 has been completed after of the scheduled display time 2401A, indicating that the previous frame 401 in scenario 1 needs a long time as scheduled by the system. Before the frame 2410 in this scenario is completed after the display time 2401A, the display may have to be delayed or displayed in incomplete form, resulting in low display quality. Assuming the current frame 2420 is similar in complexity to the previous frame 2410, the system may estimate that the time needed for rendering the current frame 2420 is approximately the same to the time needed for rendering the previously frame 2410. Thus, the system may first determine the display time 2401B for the current frame 2410 based on the target frame rate. Then, the system may determine the start time 2405 based on the processing time duration of the previous frame 2410 and safety margin 2403B. Comparing to the previously frame 2410, the system may start to process the current frame 2420 at an earlier time 2405, allowing the current frame 2420 to be generated right before the scheduled display time 2401B, without causing delay or causing any incomplete image to be displayed, providing a higher display quality.

As an example and not by way of limitation, for the scenario 3, the processing process of the previous frame 2410 may start at the start time 2402A and may be right before the display time 2401A. The system may determine that the previous frame 2410 in scenario 1 has been right before the scheduled display time 2401A, indicating that the previous frame 2401 in scenario 1 was just on time for the scheduled display time, without delay or wasting the computational resources. Assuming the current frame 2420 is similar in complexity to the previous frame 2410, the system may estimate that the time needed for rendering the current frame 2420 is approximately the same to the time needed for rendering the previously frame 2410. Thus, the system may first determine the display time 2401B for the current frame 2410 based on the target frame rate. Then, the system may determine the start time 2402B based on the processing time duration of the previous frame 2410 and safety margin 2403B. Comparing to the previously frame 2410, the system may start to process the current frame 2420 at exact the same time, allowing the current frame 2420 to be generated right before the scheduled display time 2401B, without causing delay or causing any incomplete image to be displayed, providing a higher display quality.

It is notable that in the above discussed scenarios, in particular embodiments, the current frame 2420 may or may not have the same complexity level with the previous frame. For example, the current frame may have an increased complexity level comparing to the previous frame and thus, may need a longer time to process. The current frame may have a decreased complexity level comparing to the previous fame and thus may need a shorter time to process. The system may estimate the complexity level of the current frame and the corresponding time it needs to be processed based on a number of factors including, for example, but not limited to, the number of surfaces, the sizes of the bounding boxes of the surfaces, the transparency of the surfaces, the overlapping of the surfaces, the 2D or 3D characters of the surfaces or objects, etc. The system may estimate the time duration needed for rendering the current frame based on the time needed for the previous frame, the increase or decrease in the computational amount, and the safety margin to determine the start time for processing the current frame. By using this feedback or feedforward loop, the system may accurately determine the start time for processing the current frame and provide optimal display quality without causing waste in the computational resources. In particular embodiments, the system may use the direct proceeding frame of the current frame to estimate the computation time. In particular embodiments, the system may use multiple previously frame to estimate the computation time (e.g., using an average of previously render frames).

In particular embodiments, the system may dynamically allocate the computational resources based on the estimated amount of computation needed for rendering the current frame. For example, when the system determine an increase in the computational amount, the system may use one or more methods to increase the computational capacity of the system by, for example, but not limited to, turning on a second or an extra processing unit, increasing the operating voltage and frequency of the processing units, adjusting the foveated rendering ratio (to reduce the amount of computation), etc. The system may combine one or more methods to address a computational amount increase in the current frame to have more computational capacity. As another example, when the system determine a decrease in the computational amount, the system may use one or more methods to decrease the computational capacity of the system by, for example, but not limited to, turning off the second or extra processing unit, decreasing the operating voltage and frequency of the processing units, adjusting the foveated rendering ratio (to have more high resolution area), etc. The system may combine one or more methods to address a computational amount decrease in the current frame to save power consumption or to have better display quality.

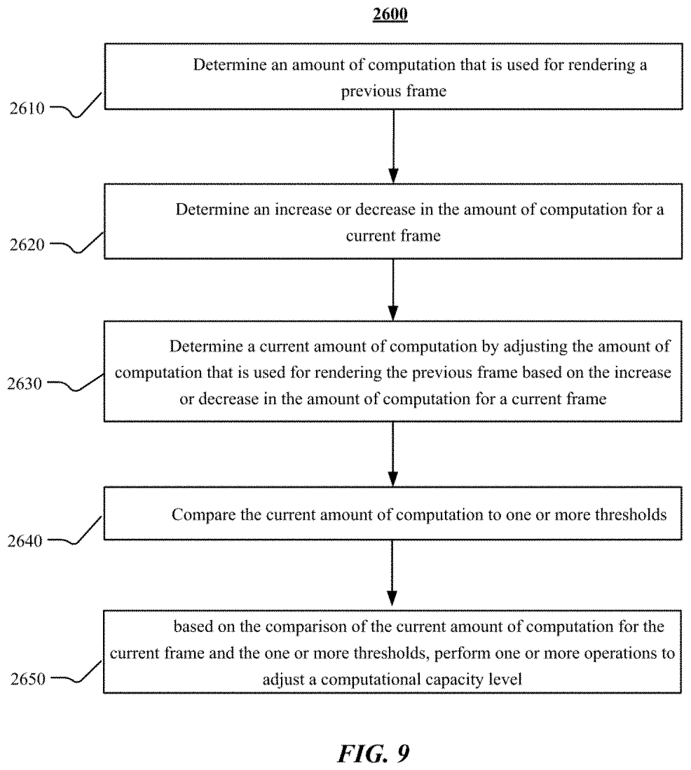

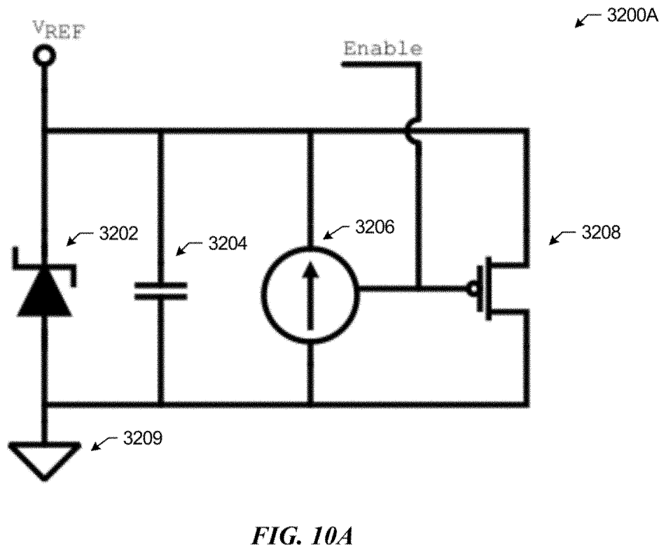

FIG. 8A illustrates an example process 2500A for dynamically allocating computational resources. For example, L1 in FIG. 5A may indicate the computational capacity level corresponding to one single processing unit (or processing pipeline). L2 may indicate the computational capacity level corresponding to two processing units. L1−T1 may correspond to the computational capacity level corresponding to one single processing unit with reduced voltage and frequency (to reduce the power consumption). L1+T1 may correspond to the computational capacity level corresponding to the one single processing unit with increased voltage and frequency (to increase the computational capacity). L2−T2 may correspond to the computational capacity level corresponding to two processing units with reduced voltage and frequency. L2+T2 may correspond to the computational level of two processing units with increased voltage and frequency. In particular embodiments, turning on the second processing unit may allow the system to have 70% extra computational capacity.

In particular embodiments, the system may estimate the computational amount that is needed for rendering the current frame and compare that to the computational capacity level and the thresholds (e.g., L1−T1, L1, L1+T1, L2−T2, L2, L2+T2) corresponding to the ranges of computational capacity changes by adjusting the operating voltage and frequency. For example, the system may determine the amount computation that is needed to generate the current frame is under the level L1−T1. The system may reduce the operating volage and frequency to save some power of the processing unit. If the system determines that the amount of computation that is needed for rendering the current frame is above L1 but below L1+T1, the system may increase the operating voltage and frequency of the single processing unit without turning on the second processing unit. If the system may determine that the amount of computation that is needed is above the level of L1+T1, the system may turn on the second processing units. Optionally, the system may reduce the operating voltage and frequency to save some power. If the system determine that the amount of computation that is needed is above the level of L2, the system may turn on the second processing unit and increase the operating voltage and frequency to further increase the computational capacity. If the system determines that the amount of computation needed is above the level of L2+T2, the system may adjust the foveated rendering ratio to reduce the high resolution area and reduce the amount the computation to be within the range of the system capacity. The system may have a smaller display region for high-resolution image area but may keep the target frame without causing delay or incomplete images.

FIG. 8B illustrates an example process 2500B for dynamically adjusting the ratio of foveated rendering. For example, the system may have two or more regions having different rendering resolutions. The region that enclose the user's gazing point 2513 may be the high-resolution region 2512. The region that is farer to the gazing point 2513 may be a low-resolution region. The two regions may have a boundary 2514. When the system determines that the amount computation that is needed for rendering the current frame or next frame is beyond the capacity of the processing units (even after turning on the second processing unit and increasing the operating voltage and frequency), the system may adjust the boundary 2514 to a smaller size boundary 2515. As a result, the rendered image may have a smaller high-resolution area and may need less computational capacity of the system. Even the image has a smaller high-resolution area, the affects on the display quality may be very limited because the system still provides high-resolution image in the region enclosing the user's gazing point 2513. However, the system may be able keep up with the target framerate without causing delayed display or incomplete rendering.

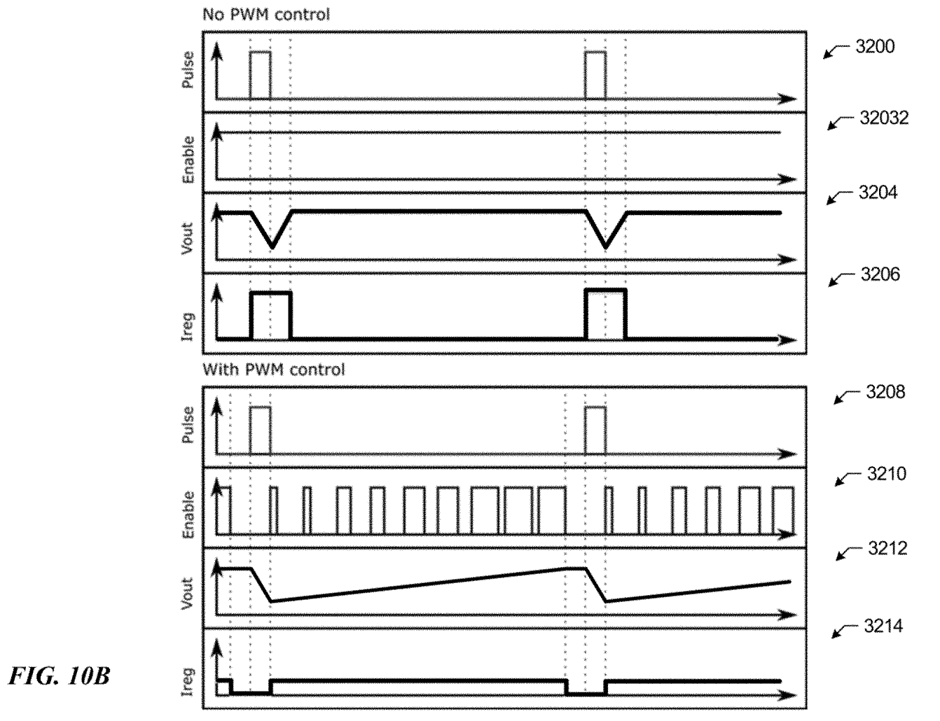

FIG. 9 illustrates an example method 2600 for dynamically adjusting computational capacity based on estimated amount of computation for the current frame. The method may begin at step 2610, where a computing system may determine, an amount of computation that is used for rendering a previous frame. At step 2620, the system may determine an increase or decrease in the amount of computation for a current frame. At step 2630, the system may determine a current amount of computation by adjusting the amount of computation that is used for rendering the previous frame based on the increase or decrease in the amount of computation for a current frame. At step 2640, the system may compare the current amount of computation to one or more thresholds. At step 2650, the system may, based on the comparison of the current amount of computation for the current frame and the one or more thresholds, perform one or more operations to adjust a computational capacity level. In particular embodiments, the one or more operations may include: turning on an extra processing unit in addition to a current operating processing unit; increasing an operating voltage and frequency of the current operating processing units; or adjusting a foveated rendering ratio to adjust the amount of computation for the current frame.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for dynamically adjusting computational capacity based on estimated amount of computation for the current frame including the particular steps of the method of FIG. 9, this disclosure contemplates any suitable method for dynamically adjusting computational capacity based on estimated amount of computation for the current frame including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

### Gate Driving Methods to Reduce Peak Converter Currents

The present embodiments include gate driving methods to reduce boost converter peak currents for handheld controller devices. In particular embodiments, a device includes a controller configured to regulate one or more voltages applied to a gate of a transistor. In particular embodiments, the controller may be further configured to generate a gating signal and transmit the gating signal to the transistor. For example, in particular embodiments, the gating signal may include a pulse width modulation (PWM) signal configured to activate or deactivate the transistor. In particular embodiments, the controller may be further configured to modulate the PWM signal and transmit the modulated PWM signal to control an activation period or deactivation period of the transistor. For example, in particular embodiments, modulating the PWM signal may include altering a duty cycle of the PWM signal over a predetermined time interval, such that the activation period controls a voltage charging level of a reference voltage associated with the transistor and the deactivation period controls a voltage discharging level of the reference voltage associated with the transistor.

As used herein, “extended reality” may refer to a form of electronic-based reality that has been manipulated in some manner before presentation to a user, including, for example, virtual reality (VR), augmented reality (AR), mixed reality (MR), hybrid reality, simulated reality, immersive reality, holography, or any combination thereof. For example, “extended reality” content may include completely computer-generated content or partially computer-generated content combined with captured content (e.g., real-world images). In some embodiments, the “extended reality” content may also include video, audio, haptic feedback, or some combination thereof, any of which may be presented in a single channel or in multiple channels (such as stereo video that produces a three-dimensional (3D) effect to the viewer). Furthermore, as used herein, it should be appreciated that “extended reality” may be associated with applications, products, accessories, services, or a combination thereof, that, for example, may be utilized to create content in extended reality and/or utilized in (e.g., perform activities) an extended reality. Thus, “extended reality” content may be implemented on various platforms, including a head-mounted device (HMD) connected to a host computer system, a standalone HMD, a mobile device or computing system, or any other hardware platform capable of providing extended reality content to one or more viewers.

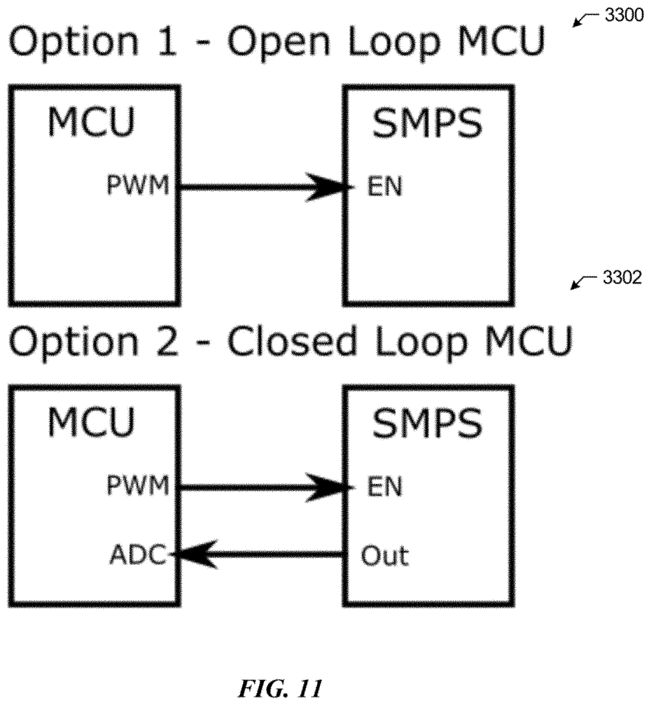

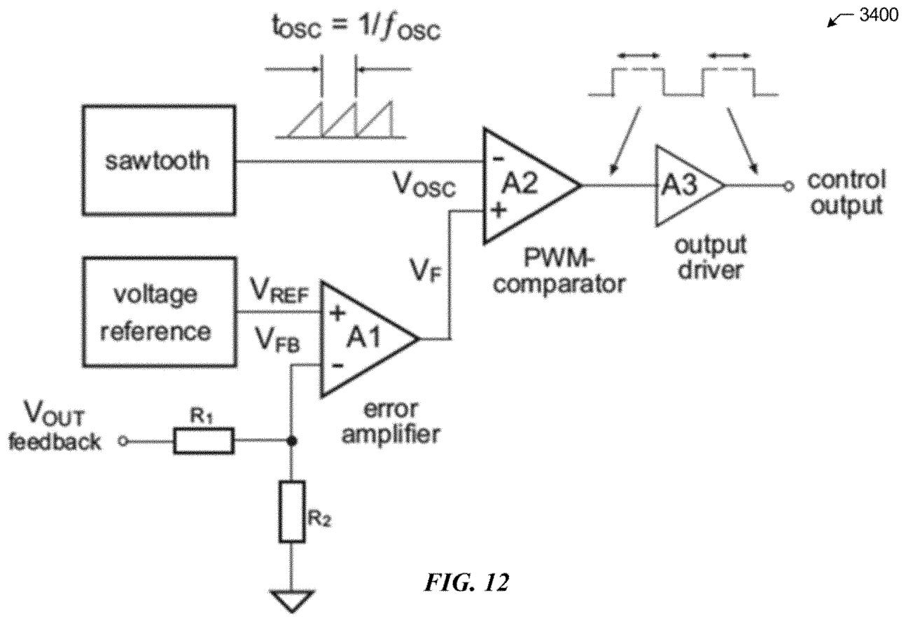

FIG. 10A illustrates a boost converter gate drive circuitry 2200A, in accordance with presently disclosed embodiments. In particular embodiments, the boost converter gate drive circuitry 2200A may include a diode 2202 (e.g., Zener diode), a capacitance 2204 (e.g., gate-to-drain capacitance C_{dg}), a current source 2206, and a switching device 2208 (e.g., metal-oxide-semiconductor field-effect transistor (MOSFET), thin-film transistor (TFT), and so forth). In particular embodiments, the diode 2202 (e.g., Zener diode), the capacitance 2204 (e.g., gate-to-drain capacitance C_{dg}), and the current source 2206 may be coupled in parallel to the switching device 2208 (e.g., MOSFET, TFT)).

In particular embodiments, in applications requiring periodic, high current light-emitting diode (LED) strobing (e.g., constellation tracking, low persistence backlight drive), it may be suitable to utilize the entire time between strobes to recharge the voltage output signal 2209. For example, in particular embodiments, the voltage output signal 2209 may include, for example, a linear ramp up to set voltage over the entire time between strobes. In particular embodiments, power reduction may also be achieved due to the lower switch currents, as well as avoiding higher switch duty-cycle due to voltage drooping or sagging. For example, in particular embodiments, the boost converter gate drive circuitry 2200A may include a “soft-start” mechanism that limits drive current on start-up to avoid issues caused by in-rush currents. In one embodiment, this may be achieved based on the capacitor 2204 and the current source 2206, which may be collectively utilized to control the ramp-rate of the voltage reference V_{Reference}. During normal operation of the boost converter gate drive circuitry 2200A, the “soft-start” may occur only once and may be initiated by asserting the enable input (“Enable”).

In particular embodiments, when the enable input (“Enable”) is deasserted, the current source 206 may be disabled and the V_{Reference} capacitance 204 may be actively discharged. Indeed, by modulating the enable input (“Enable”), the present embodiments may control the V_{Reference} voltage level and maintain the “soft-start” mode of the boost converter gate drive circuitry 200A. For example, in particular embodiments, the activation of the period of the modulated enable input (“Enable”) may control the voltage level to which the voltage reference V_{Reference} charges, while the deactivation period of the modulated enable input (“Enable”) may control the voltage level to which the voltage reference V_{Reference} discharges. In particular embodiments, the modulation technique may include pulse width modulation (PWM) with fixed period. In another embodiment, the PWM signal may control activation periods and deactivation periods individually (e.g., variable period).

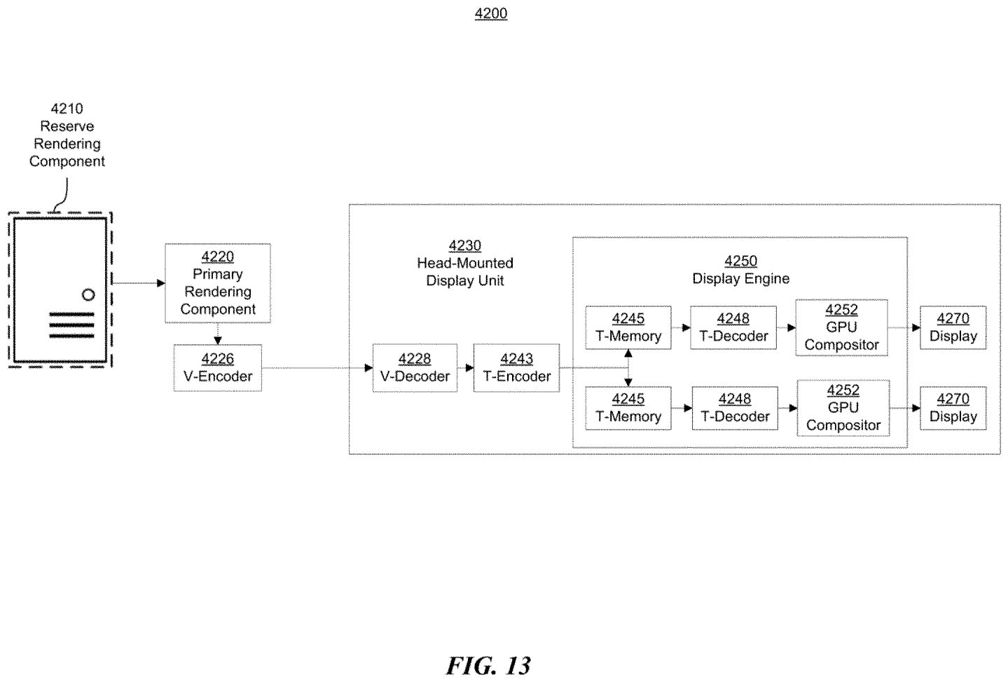

FIG. 10B illustrates first timing signals 3210, 3212, 3214, and 3216 without the present modulated PWM techniques and second timing signals 3218, 3220, 3222, and 3224 with the present modulated PWM techniques, in accordance with presently disclosed embodiments. In particular embodiments, the second timing signals 3218, 3220, 3222, and 3224 may operate according to the process described above with respect to FIG. 10A. For example, in particular embodiments, when the enable input 3220 (“Enable”) is deasserted, the current source 3206 may be disabled and the V_{Reference} capacitance 3204 may be actively discharged. Indeed, by modulating the enable signal 3220, the present embodiments may control the V_{Reference} voltage level and maintain the “soft-start” mode as illustrated by voltage output 3222. For example, in particular embodiments, the activation of the period of the modulated enable signal 3220 may control the voltage level to which the voltage reference V_{Reference} charges, while the deactivation period of the modulated enable signal 3220 may control the voltage level to which the voltage reference V-_{Reference} discharges. FIG. 11 illustrates an open loop PWM modulation topology 3300 and closed loop PWM modulation topology 3302, in accordance with presently disclosed embodiments. In particular embodiments, PWM modulated enable control may be implemented utilizing both the open and closed loop topologies 3300 and 3302, respectively. In particular embodiments, for the open-loop topology 3300, an analysis of the semiconductor process variation may be performed. The semiconductor process variation may include, for example, the output current variation of the current source 3206, charge capacitance 3204 capacitance variation, and discharge circuit (diode 3202) impedance variation. With this information, an optimized modulation profile may be determined. In particular embodiments, for the closed-loop topology 3302, feedback of the voltage output signal 3209 may be received to a microcontroller. For example, in particular embodiments, a proportional-integral-derivative (PID) loop may be utilized to control the modulated enable signal 3220 to track a predetermined output ramp profile.

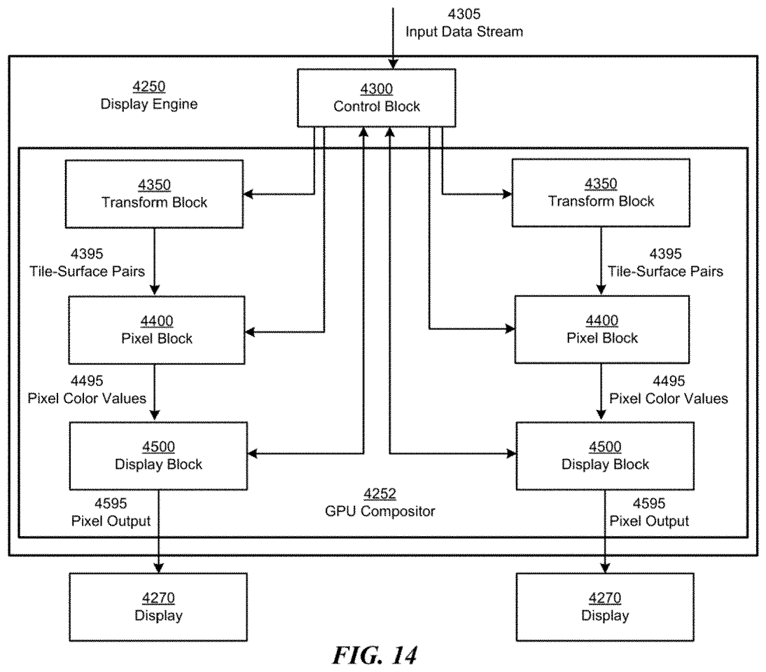

FIG. 12 illustrates an analog example 3400 of an open loop PWM modulation topology and closed loop PWM modulation topology, in accordance with presently disclosed embodiments, in accordance with presently disclosed embodiments.

### Joint Color Image and Texture Data Compression

Because artificial reality devices involve creating digital scenes or superposing computer-generated imagery onto a view of the real world, they provide a platform for designers and engineers to provide new forms of information, entertainment, or methods of collaboration. For example, artificial reality devices may allow users to communicate, seemingly in person, over long distances, or assist users by informing them of the environment around them in an unobtrusive manner. Because artificial reality experiences can often be customized, the user's experience with artificial reality may be deeply personal and highly engaging if presented with sufficient clarity and convenience.

One way that artificial reality experiences can augment human ability is with computer-generated images and/or text added to the real world, as in an augmented or mixed reality. From this simple principle, a variety of compelling use cases can be considered. Labels (e.g., texts, glyphs, etc.) or images describing a real-world object may be fixed in the world space (e.g., location-aware labels acting as street signs or providing a live map of a bike path), or images fixed to a real-world object as it moves through the space (e.g., a label added to a bus as it going on its route that provides detailed information about its route or capacity). Labels could also be used to help a user navigate through an unfamiliar city (e.g., creating a waypoint for the nearest restroom), or help find a friend in a crowd (e.g., a socially-aware waypoint fixed to another user). Other experiences worth considering may be based on interactions with real-world objects. For example, a user could “project” video onto a wall or screen that allows for the video to be played and visible to only herself or to others with access to a shared augmented space. As another example, a user could fix computer-generated text to a physical object to act as an augmented-reality book or magazine. Content could be displayed relative to the object (allowing a user to physical asset aside an augmented-reality) or could be displayed in a fixed relation to the user's (e.g., a tutorial video constantly playing in a corner of the view). Presented media could be customized to the user, so that the same content display space could content relevant to each person viewing the same physical space. As another example, a user could interact with computer-generated graphics by “touching” an icon, or “manipulating” the computer-generated images manually. These graphics could be shown to multiple users working on a project, enabling opportunities for team collaboration (e.g., multiple architects working on a three-dimensional digital prototype in a building together in real-time).

To facilitate use, the display that outputs the computer-generated graphics should be intuitive, constantly accessible, and unobtrusive. One approach for displaying high definition artificial reality graphics to a user is based on a head-mounted display. The user wears an apparatus, such as a visor, headset, or glasses, capable of displaying computer graphics display. In augmented or mixed reality experiences, the computer graphics can be seen alongside, or on top of, the physical world. However, rendering these computer graphics is computationally intensive. Therefore, in most cases rendering is performed by powerful computers communicatively attached (e.g., via a cable or wireless communication protocol, such as Bluetooth) to a head-mounted display. In such a configuration, the head-mounted display is limited by bulky cords, bandwidth and power limitations, heat restrictions, and other related constraints. Yet, the limits of these constraints are being pushed. Head-mounted displays that are comfortable and efficient enough for day-long wearing, yet powerful enough to display sophisticated graphics are currently being developed.

One technique used to reduce actual display size without impacting apparent display size is known as a scanning display. In a scanning display, multiple smaller images are combined to form a larger composite image. The scanning display uses source light, one or more scanning elements comprising reflectors, and an optics system to generate and output image light. The output image light may be output to the eye of the user. The source light may be provided by emitters, such as light-emitting diodes (LEDs). For example, the light source may be an array of 2560×1440 LEDs. The reflectors may be any suitable reflective surface attached to the scanning element. In particular embodiments, the scanning element may be a scanning mirror driven using one or more microelectromechanical systems (MEMS) components. The optics system may comprise lenses used to focus, redirect, and otherwise augment the light. The scanning element may cause the source light, treated by light guiding components, to be output to the eye of the user in a specific pattern corresponding to a generation pattern used by the emitters to optimize display draw rate. Because, for example, all emitters need not be active at once, and in addition to a variety of other factors, scanning displays may require less power to run, and may generate less heat, than traditional display comprised of the same emitters. They may have less weight as well, owing in part to the quality of the materials used in the scanning element and optics system. One consequence of using a scanning display is that in exchange for, e.g., power, weight, and heat efficiency, a scanning displays may not perfectly display images as presented to them, e.g., images intended for traditional displays. There may be non-uniform distortions such as geometric warping of images and distortion of colors and specifically brightness. As is explained further herein, these distortions can be corrected by post-processing graphics to-be displayed to counteract the distortion before they are passed to the display, creating the effect that there is no distortion. Although this disclosure describes displays in a particular manner, this disclosure contemplates any suitable displays.

Since its existence, artificial reality (e.g., AR, VR, MR) technology has been plagued with the problem of latency in rendering AR/VR/MR objects in response to sudden changes in a user's perspective of an AR/VR/MR scene. To create an immersive environment, users may need to be able to move their heads around when viewing a scene and the environment may need to respond immediately by adjusting the view presented to the user. Each head movement may slightly change the user's perspective of the scene. These head movements may be small but sporadic and difficult, if not impossible, to predict. A problem to be solved is that the head movements may occur quickly, requiring that the view of the scene be modified rapidly to account for changes in perspective that occur with the head movements. If this is not done rapidly enough, the resulting latency may cause a user to experience a sensory dissonance that can lead to virtual reality sickness or discomfort, or at the very least, a disruption to the immersive nature of the experience. Re-rendering a view in its entirety to account for these changes in perspective may be resource intensive, and it may only be possible to do so at a relatively low frame rate (e.g., 60 Hz, or once every 1/60th of a second). As a result, it may not be feasible to modify the scene by re-rendering the entire scene to account for changes in perspective at a pace that is rapid enough (e.g., 200 Hz, once every 1/200th of a second) to prevent the user from perceiving latency and to thereby avoid or sufficiently reduce sensory dissonance. One solution involves generating a two-dimensional (2D) image of an object's texture from a particular view of the object, which maps to a three-dimensional (3D) “surface” of the object within the scene. A surface, or texture image, is comprised of object primitives that represent a particular view of the object. A surface corresponds to one or more objects that are expected to move/translate, skew, scale, distort, or otherwise change in appearance together, as one unit, as a result of a change in perspective. Instead of re-rendering the entire view, a computing system may simply resample these surfaces from the changed perspective to approximate how a corresponding object would look from the changed perspective. This method may significantly reduce the rendering processing and thus ensure that the view is updated quickly enough to sufficiently reduce latency. Resampling surfaces, unlike re-rendering entire views, may be efficient enough that it can be used to modify views within the allotted time—e.g., in 1/200th of a second—with the relatively limited processing power of a computing system of a HMD. It may not be feasible for a system that is physically separate from the HMD (e.g., a separate laptop or wearable device) to perform the resampling process because the time scales involved in the resampling process are extremely small. For example, if the resampling process were to be performed in a physically separate system, the HMD would have to transmit information about the current position and orientation of the HMD, wait for the separate system to render the new view, and then receive the new view from the separate system. The present embodiments, to further speed up the overall rendering process, specifically the resampling process, provide compression techniques for selectively encoding certain pixel blocks of an image based on the concept of Principal Component Analysis if the color values within the block are highly correlated to each other. The present embodiments also disclose the adaptive range packing technique that leverages the similarities between the pixel values within a pixel block to represent the pixel values with reduced number of binary bits.

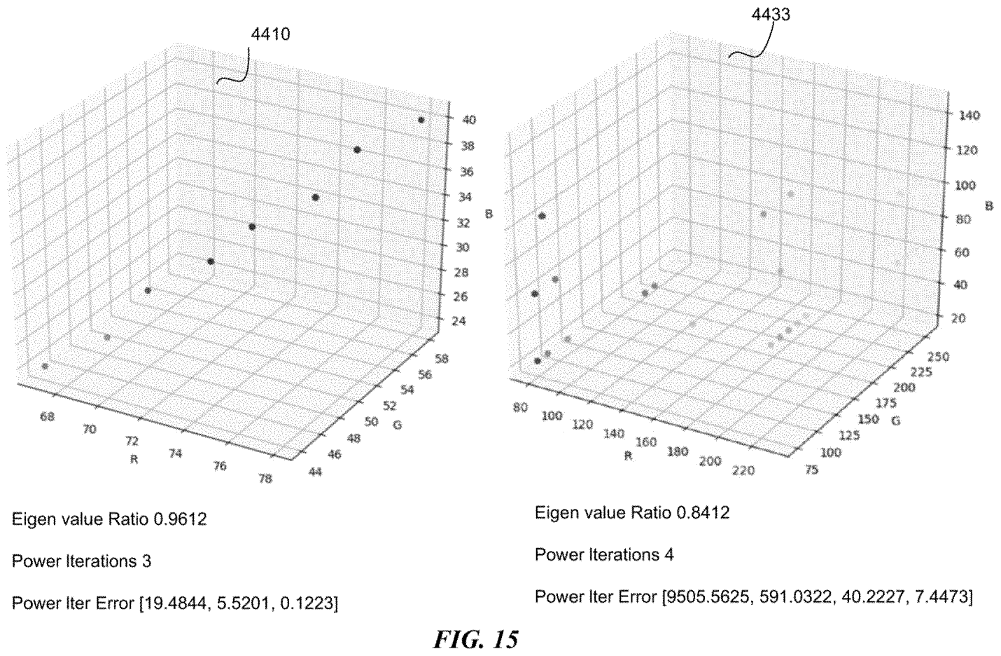

FIG. 13 illustrates an artificial reality graphics rendering and display system 4200. In particular embodiments, the rendering and display system 4200 may comprise a reserve rendering component 4210. The reserve rendering component 4210 may be a remote rendering component used to perform supplemental rendering, or pre-render elements that can be prepared with less requirement of interactivity. For example, the reserve rendering component 4210 may be a rendering server provided through a cloud computing network or local area network that handles pre-rendering of streaming video or other non-interactive components. The user may provide her own reserve rendering component 4210 or may gain access to a reserve rendering component 4210 as part of a subscription plan. The reserve rendering component may communicate wirelessly or through one or more wired connections to a primary rendering component 4220. The primary rendering component 4220 may be a standalone device such as a laptop or desktop computer, video game console, or any other suitable local graphics rendering system, or a device easily-worn on the user's body, such as a cellphone, tablet, or any other suitable compact graphics rendering system. The reserve rendering component 4210 and/or primary rendering component 4220 may perform several processes of a typical rendering pipeline. In particular embodiments, the primary rendering component 4220 may be capable of rendering interactive graphics based on three-dimensional (“3D”) models defined by a plurality of polygons and rendering instructions sufficient to support a frame refresh rate up to or surpassing 60 frames per second.

The primary rendering component 4220 may receive primary rendering data for a rendering request. The primary rendering data may include two- or three-dimensional models, textures, and instructions for rendering computer-generated images, and other suitable information. The primary rendering component 4220 may perform initial steps to render aspects of the artificial reality scene based on the received primary rendering data. For example, the primary rendering component 4220 may perform visibility computations using ray tracing, rasterization, or other suitable techniques to determine which polygons of which 3D models of virtual objects in a virtual scene are visible through which pixels of a display. Based on the visibility determinations, the primary rendering component 4220 may perform shading computations to determine the appropriate color for each pixel. In particular embodiments, the primary rendering component4 220 may receive compressed or decompressed streaming video data from the reserve rendering component 4210 at a rate of 30 frames per second, or similar. The primary rendering component 4220 may combine data received from the reserve rendering component 4210 with data generated by the initial rendering steps.

In particular embodiments, one or more specialized object primitives, e.g., “surfaces,” for use by a display engine 4250 may be generated. As an example, the primary rendering component 4220 may generate surfaces by first rendering 2D images from 3D models, as in a typical rendering pipeline. The primary rendering component 4220 may then generate surfaces from the 2D images using an additional post-processing method. As another example, the primary rendering component 4220 may directly output surfaces from 3D models, eliminating extra steps directed only to rendering 2D images. As another example, the primary rendering component 4220 may output 2D images from 3D models to a display engine 4250. The display engine 4250 may generate surfaces using an additional post-processing method based on the 2D images. In particular embodiments, the output of the primary rendering component 4220 may be encoded by the v-encoder 4226, then transmitted to the v-decoder of the head-mounted display unit 4230.

Surfaces may comprise information useful for rendering one or more virtual objects of an artificial reality scene. The information may include location and/or position data for the surface in the scene, specified in the coordinate system of the view space relative to the virtual camera/viewer (alternatively, location of the surface may also be specified in any other suitable coordinate system, such as the world space coordinate system). The surface may further include texture data, represented by one or more texel arrays. Thus, in particular embodiments, a “surface” may be considered as a rectangular texture with a transformation matrix to specify its location within a scene. Each texel in the texel array may have color information and a 2D coordinate within the texel array (e.g., specified in (u, v) coordinates). In particular embodiments, the color information of each texel may indicate the intensity of several color channels (e.g., red, green, and blue) and alpha information that indicates the texel's transparency level (e.g., completely transparent, completely opaque, or somewhere in between). In other embodiments, the color information of a texel may indicate the intensity of red, green, and blue without separately specifying the transparency level. In this case, the value for each color may be pre-multiplied by the texel's associated transparency level (e.g., if the texel is fully transparent with an alpha level of 0, then the red, green and blue values for that texel would all be zeroed-out by being multiplied by the 0 alpha level).

The texture data of a surface may be generated based on the result of a standard graphic rendering pipeline, embodying techniques to optimally determine the colors that should be displayed by the pixels of a display or image based on the perspective of a viewer in a three-dimensional scene. In particular embodiments, the display engine 4250 may limit the number of surfaces (e.g., a maximum of 16 surfaces or any other suitable number of surfaces) that it will process to ensure sufficient simplicity in the scene so that performance demands can be met (e.g., to output frames at 200-300 hertz). Therefore, certain virtual objects in the artificial reality scene may be grouped according to any suitable rule. Each surface may be a representation of one or more objects within the scene that are expected to move/translate, skew, scale, distort, or otherwise change in appearance together, as one unit, as a result of a change in a user's perspective of the scene (e.g., resulting from a HMD on a user's head moving to a different position and/or orientation). As an example and not by way of limitation, an avatar of a person and a hat worn by the avatar may correspond to one surface if it is determined that person and the hat would move/translate, skew, scale, distort, or otherwise change in appearance together, as one unit. In particular embodiments, a surface may correspond to sets of points (e.g., points making up an object) that are expected to move/translate, skew, scale, distort, or otherwise change in appearance as a single unit when a user's perspective of a scene changes.

The primary rendering component 4220 may communicate with a head-mounted display unit 4230 through one or more wired or wireless connections. In particular embodiments, a user may be able to select how the primary rendering component 4220 and head-mounted display unit 4230 communicate based on the user's needs. The head-mounted display unit 4230 may be configured to receive data, such as surfaces and other rendering instructions, from the primary rendering component 4220. The head-mounted display unit 4230 may prepare to display an artificial reality scene to a user based on the received data. In particular embodiments, the head-mounted display unit 4230 may comprise a display engine 4250 and one or more displays 4270. In particular embodiments, the displays 4270 may be scanning displays, including all necessary emitters, scanning elements, and optical systems. The head-mounted display unit 4230 may further comprise additional components not shown that facilitate the rendering and display of the artificial scene. These may include additional image processing components, eye-tracking components, heat detection components, any other suitable components, or any combination thereof. Although this disclosure describes rendering components in a particular manner, this disclosure contemplates any suitable rendering components.

In particular embodiments, the display engine 4250 and displays 4270 of the head-mounted display may be configured specifically to enable a fast frame display or refresh rate. In typical interactive graphics rendering systems, a target frame rate may be at or around sixty frames per second. While this is sufficient for the images to appear as crisp, smooth moving video in traditional systems, it may not be sufficient for artificial reality. Because of the immersive nature of the artificial reality experience, and further exacerbated by the head-mounted nature of the display and its proximity to the user's eyes, artificial reality rendering and display system 4200 may target much higher frame display rates, e.g., upwards of two to three hundred frames per second, in order to display images responsive to changes in the user's viewpoint and/or movement (e.g., head and/or eye movement). If this is not done quickly enough, the resulting latency may cause a user to experience a sensory dissonance that can lead to virtual reality sickness or discomfort. In particular embodiments, the artificial reality rendering and display system 4200 may be capable of tracking and reacting to the user's eye movements. To provide smooth video when reacting to eye movement, the system 4200 may target even higher display rates during particularly intense periods, e.g., bursts of up to eight hundred frames per second.

The entire system may be configured with these fast display rate benchmarks in mind. A target frame rate of 4200 frames per second is roughly equivalent to one frame every 5 milliseconds. Significant time is lost by transmitting movement data to, and updating rendering data from, a powerful graphics processor over wireless, or even wired connections. Therefore, at least some amount of graphics preparation must occur in a head-mounted unit, reducing the time lost in transmission. However, a head-mounted display unit 4230 has weight, power, and space constraints that must be adhered to for the comfort of the user. These weight, power, and space constraints restrict the components and computational power available for a head-mounted display unit 4230. In fact, using conventional approaches, components available for a head-mounted display unit 4230 suitable for long-term wear are incapable of rendering artificial reality scenes from 3D models comprising polygons with suitable lighting at 60 frames per second, let alone the 4200 or more necessary for an immersive experience.

One solution to this problem involves a powerful primary rendering component 4220 performing the complex graphics generation work needed to generate surfaces at around 60 frames per second. A display engine 4250 of a head-mounted display unit 4230 may comprise hardware components powerful enough to adjust or re-sampling what the primary rendering component 4220 produces based on a user's movements between updates from the primary rendering component 4220. The display engine 4250 may rapidly respond to perspective changes created by a user's movement to reprocess the output of the primary rendering component 4220, warping or otherwise adjusting the output of the primary rendering component 4220 until the primary rendering component 4220 has prepared another frame for display. For example, the primary rendering component 4220, as described, may render 2D images of virtual objects in a 3D scene at typical rates, e.g., around sixty frames per second. The 2D images may be used to generate surfaces. Each surface may comprise location information that indicates the surface's 3D location relative to the viewer and texture information for the virtual objects they represent, including the results of complex lighting effects, occlusion determination, and implementation of other rendering techniques performed by the primary rendering component 4220. The primary rendering component 4220 may send the surfaces to the display engine 4250. The display engine 4250 may then use updated information about, e.g., the position and/or orientation of the user to re-sample the surfaces from the current user perspective and warp the surface to accommodate characteristics of the display. The simplified geometries of the scene (due to the use of surfaces), along with other optimization techniques, enable the display engine 4250 to perform the task of refining and rendering the artificial scene at the desired target rates (e.g., at more than 4200 frames per second). Thus, while the primary rendering component 4220 prepares surfaces that are precise to a user's movements once every 1/60th of a second, the display engine 4250 may re-sample the output to refine the position of graphic every 1/200th of a second, filling in the gaps created by the frame rate of the primary rendering component 4220. This may create a high quality artificial reality experience for the user with smooth and seamless movement of computer generated graphics, while still providing comfortable equipment.

Another solution to this problem involves a compression technique that jointly encodes color components of the surfaces or 2D images (e.g., red, blue, green color channels), which is referenced herein as the joint-color mode. Typically, pixels are associated with three dimensions, or channels, of colors (e.g., red, blue, green color channels). As discussed with additional details below, the joint-color mode encodes the three channels of colors together if there is strong RGB color correspondences between pixels in a pixel block. If not, the pixels color values are encoded separately using standard encoding techniques. As illustrated in FIG. 13, t-encoder 4243 of the HMD 4230 encodes the surfaces based on either joint-color mode or standard mode depending on the color correspondences. The encoded data is stored in the t-memory 4245 residing within the display engine 4250 of the HMD 4230. When the color information for a particular surface is needed, the GPU compositor 4252 accesses the decoded pixel values from t-decoder 4248 which access the compressed data from t-memory 4245.

Yet another solution to this problem involves a compression technique referred to as the adaptive range packing technique that uses two-dimensional arrays of values to represent various types of data such as those corresponding to image colors, depth, or motion. Similar to the joint-color mode described herein, if the data corresponds to image colors, the data may be encoded, or compressed, by the t-encoder 4243 illustrated in FIG. 2, then stored in t-memory 4245. For a different type of data, the same, or different, encoder may encode the data and store the encoded data in a memory that is accessible by a system component appropriate for handling that type of data.

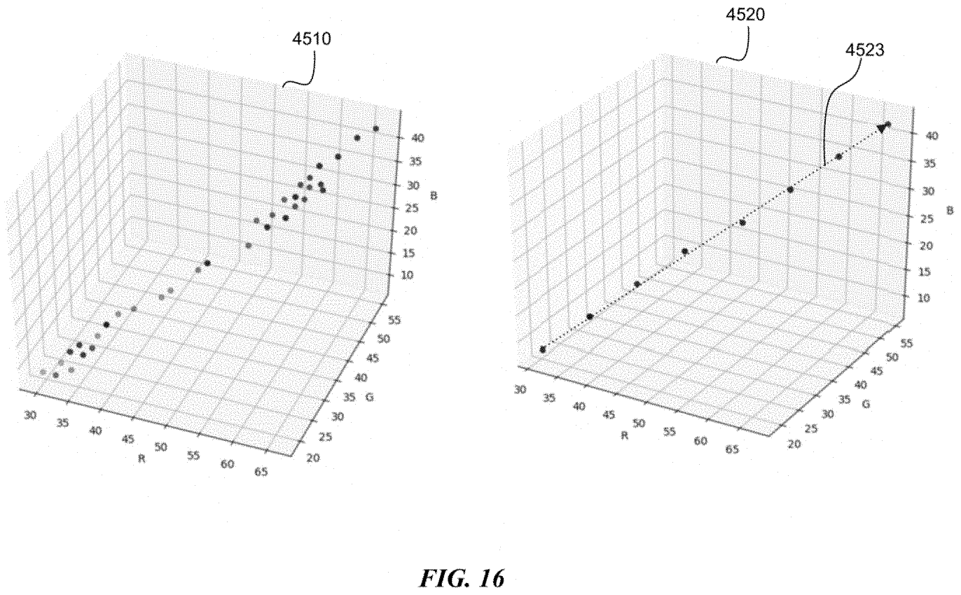

FIG. 14 illustrates a system diagram for a display engine 4250. The display engine 4250 may comprise four types of top level blocks. As shown in FIG. 14, these blocks may include a control block 4300, transform blocks 4350, pixel blocks 4400, and display blocks 4500. One or more of the components of the display engine 4250 may be configured to communicate via one or more high-speed bus, shared memory, or any other suitable method. As shown in FIG. 14, the control block 4300 of display engine 4250 may be configured to communicate with the transform blocks 4350, pixel blocks 4400, and display blocks 4500, of two mirrored pipelines. In particular embodiments, each pipeline of display engine 4250 may be dedicated to preparing images for a separate display 4270 to display. Each display 4270 may be configured to display images to a user's left and right eye respectively. As explained in further detail herein, this communication may include data as well as control signals, interrupts and other instructions. The two pipelines may be capable of operating independently of the other.

In particular embodiments, the control block 4300 may receive an input data stream 4305 from the primary rendering component 4220 and initialize a pipeline in the display engine 4250 to finalize the rendering for display. In particular embodiments, the input data stream 305 may comprise data and control packets from the primary rendering component 4220. The data and control packets may include information such as one or more surfaces comprising texture data and position data and additional rendering instructions. The control block 4300 may distribute data as needed to one or more other blocks of the GPU Compositor 4252. The control block 4300 may initiate pipeline processing for one or more frames to be displayed. In particular embodiments, head-mounted display unit 4230 may comprise multiple display engines 4150 and each may comprise its own control block 4300.

In particular embodiments, transform blocks 4350 may determine initial visibility information for surfaces to be displayed in the artificial reality scene. In general, transform blocks 350 may cast rays from pixel locations on the display and produce filter commands (e.g., filtering based on bilinear or other types of interpolation techniques) to send to the pixel blocks 4400. Transform blocks 4300 may perform raycasting from the current viewpoint of the user (e.g., determined using inertial measurement units, eye trackers, and/or any suitable tracking/localization algorithms, such as simultaneous localization and mapping (SLAM)) into the artificial scene where surfaces are positioned and may produce results to send to the pixel block 400.

In general, transform blocks 4350 may each comprise a four-stage pipeline, in accordance with particular embodiments. The stages of a transform block 4350 may proceeds as follows. A ray caster may issue ray bundles corresponding to arrays of one or more aligned pixels, referred to as tiles (e.g., each tile may include 16'16 aligned pixels). The ray bundles may be warped, before entering the artificial reality scene, according to one or more distortion meshes. The distortion meshes may be configured to correct geometric distortion effects stemming from, at least, the displays 4270 of the head-mounted display 4230. Transform blocks 4300 may determine whether each ray bundle intersects with surfaces in the scene by comparing a bounding box of each tile to bounding boxes for each surface. If a ray bundle does not intersect with a surface, it may be discarded. Tile-surface intersections are detected, and corresponding tile-surface pairs 4395 are passed to the pixel blocks 4400.

In general, pixel blocks 4400 determine color values from the tile-surface pairs 4395 to produce pixel color values, in accordance with particular embodiments. The color values for each pixel are sampled from the texture data of surfaces received and stored by the control block 4300 (e.g., as part of input data stream 4305). Pixel blocks 4400 receive tile-surface pairs 4395 from transform blocks 4350 and schedule bilinear filtering. For each tile-surface pair 4395, pixel blocks 4400 may sample color information for the pixels within the tile using color values corresponding to where the projected tile intersects the surface. In particular embodiments, pixel blocks 4400 may process the red, green, and blue color components separately for each pixel. Pixel blocks 4400 may then output pixel color values 4495 to the display blocks 4500.

In general, display blocks 4500 may receive pixel color values 4495 from pixel blocks 4400, convert the format of the data to be more suitable for the scanline output of the display, apply one or more brightness corrections to the pixel color values 4495, and prepare the pixel color values 4495 for output to the displays 4270. Display blocks 4500 may convert tile-order pixel color values 4495 generated by pixel blocks 4400 into scanline- or row-order data, which may be required by the displays 4270. The brightness corrections may include any required brightness correction, gamma mapping, and dithering. Display blocks 4500 may provide pixel output 4595, such as the corrected pixel color values, directly to the displays 4270 or may provide the pixel output 4595 to a block external to the display engine 4250 in a variety of formats. For example, the head-mounted display unit 4230 may comprise additional hardware or software to further customize backend color processing, to support a wider interface to the display, or to optimize display speed or fidelity.

In particular embodiments, the control block 4300 may receive an input data stream 4305 from the primary rendering component 4220 and initialize a pipeline in the display engine 4250 to re-sample or correct artificial reality surfaces based on the user's current viewpoint. In particular embodiments, the control block 4300 may receive control packets from the primary rendering component 4220. The control packets may include one or more surfaces with texture data and position data (e.g., as defined by transformation matrices) to be rendered in the artificial reality scene.

Particular embodiments disclosed herein are directed to image compression techniques that leverage strong RGB color correspondences between pixels in a pixel block. Conventional compression techniques are typically asynchronous, thus are too slow to allow real-time encoding and decoding. To allow images to be encoded/decoded faster, embodiments of this disclosure provide a method of selectively encoding certain pixel blocks of an image based on the concept of Principal Component Analysis if the color values within the block are highly correlated to each other. The high-level idea is that, if pixel color values within a block are highly correlated to each other, the color values for the entire block can be encoded into a simplified representation that captures most of the color information. This technique, referred to as the joint-color mode, can be selectively applied to certain pixel blocks in an image if the block is suitable for the joint-color mode (e.g., high correlation of pixel color values), while other blocks of the image are encoded using the standard encoding method (normal mode).

Principal Component Analysis (PCA) is a method used to reduce the dimensionality of large data sets, by transforming a large set of variables into a smaller one that still contains most of the information in the large set. This method involves transforming multi-dimensional dataset into pairs of eigenvector and eigenvalue, each pair representing one dimension of the data set. An eigenvector, also referred to as the principal component, is a characteristic vector that represents a new dimension or a new axes of the data set, or said differently, a line or a direction representing values of the data set that are associated with the highest variance (most information). An eigenvalue is a scaling coefficient attached to the corresponding eigenvector and represents the amount of variance carried in each principal component. When transforming a data set based on eigenvectors and eigenvalues, the number of dimensions represented by the eigenvectors and eigenvalues match the number of dimensions of the data set. Thus, for example, in the context of RGB colors, representing the dataset based on PCA would produce three pairs of eigenvector and eigenvalue, since there are three channels, or dimensions, of colors (e.g., red, blue, green channels). In reference to eigenvectors and eigenvalues, determining whether to encode a pixel block based on the joint-color mode involves determining that the RGB color values of the pixel block have sufficiently strong correspondences such that one pair of eigenvector and eigenvalue can represent most of the color information of the pixel block. Thus, encoding the pixel block based on the joint-color mode means that the RGB color values of the pixel block are encoded as a single-dimensional data set represented by the line corresponding to a dominant eigenvector.

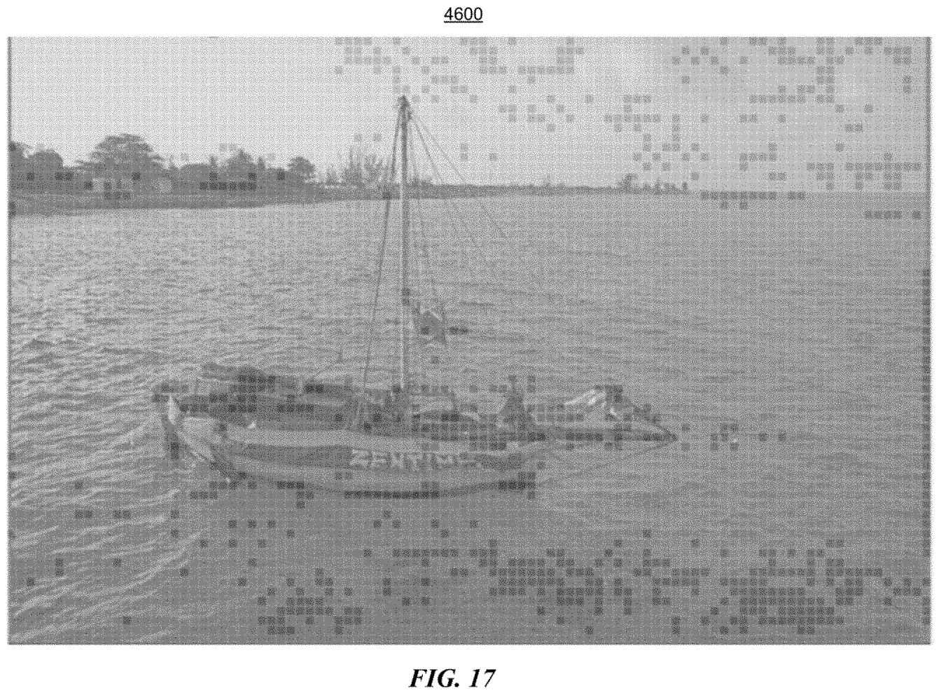

The disclosed embodiments provide techniques for jointly encoding RGB color values of certain pixel blocks if there are strong color correspondences between the RGB colors of a pixel block. In particular embodiments, determining whether to encode the pixel block using the joint-color mode involves calculating the largest eigenvalue and eigenvector for the pixel color values within a pixel block and determining whether the largest eigenvalue is significantly bigger than the other eigenvalues (indicating dominance over the other eigenvalues). In one method, the power iteration technique may be used to determine the largest eigenvalue and eigenvector for the pixel color values in a pixel block. The power iteration technique involves iteratively performing the steps of approximating an arbitrary starting vector vᵢ, multiplying the vector vᵢ by matrix A (e.g., 3×3 co-variance matrix for RGB color values of the pixel), then normalizing the resulting vector vⱼ based on the largest entry n of the resulting vector. These steps may be performed iteratively for a predetermined number of iterations (e.g., four iterations), then the resulting vector vⱼ may be checked to see if it has converged into the eigenvector corresponding to the largest eigenvalue, which may be indicated by the largest entry n corresponding to the resulting vector vⱼ (e.g., the eigenvector). If it has, then the dominance of the largest eigenvalue may be determined by comparing it to the other eigenvalues (e.g., based on the ratio between the largest eigenvalue and the sum of all eigenvalues). If the largest eigenvalue is sufficiently dominant (e.g., if the ratio is higher than a threshold ratio), the color channels of the pixel block may be jointly encoded using the joint-color mode; otherwise, the color channels of the pixel block may be encoded separately. For example, referring to the coordinate system 4410 in FIG. 15, the color values of a pixel block are illustrated as having strong color correspondences such that a line drawn through the pixels could be used to represent the distribution of the pixel values in the dataset. This line could be represented by an eigenvector, and the eigenvalue corresponding to the eigenvector may be determined as being dominant in part due to the eigenvalue having a high ratio value of, for example, 0.9612, when compared to the sum of all eigenvalues. As a counter-example, referring to the coordinate system 4433, the color values of a different pixel block are illustrated as having weak color correspondences such that a line drawn through the pixels would not be able to accurately represent the distribution of the pixel values in the dataset. Thus, an eigenvalue corresponding to the line may not be determined as being dominant in part due to the eigenvalue having a ratio value that is, when compared to the other eigenvectors, lower than a predetermined threshold (e.g., 0.8412). In particular embodiments, the threshold ratio value for the eigenvalue may be predetermined based on the type of data set (e.g., 0.96 threshold ratio for type of data corresponding to RGB values). In particular embodiments, determining the dominance of the eigenvalue may involve using other techniques such as: inverse iteration, Rayleigh quotient iteration, preconditioned inverse iteration, etc.

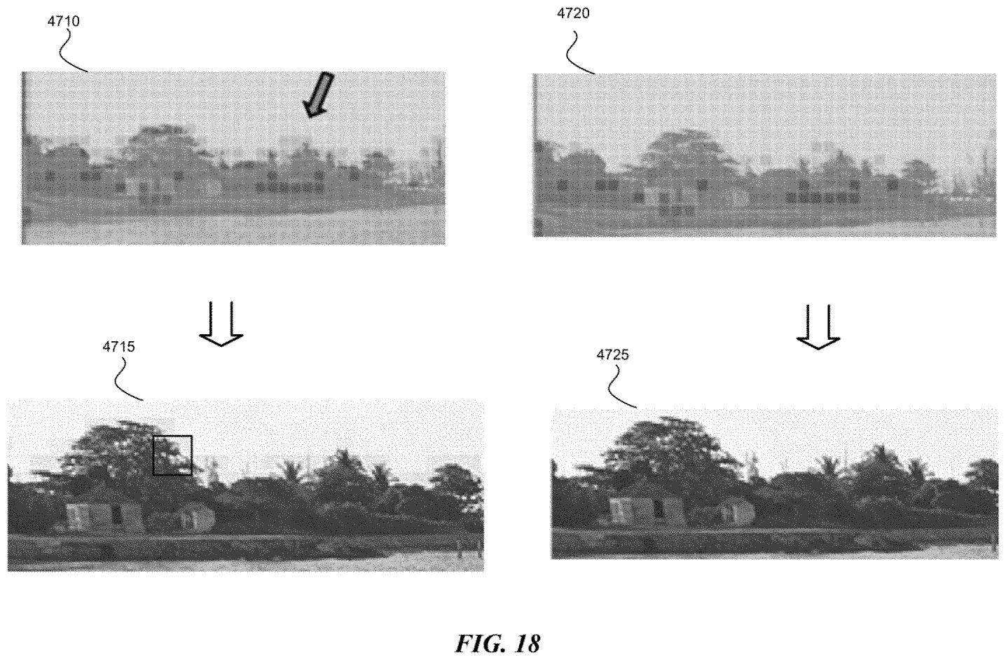

In particular embodiments, if a pixel block is to be encoded using the joint-color mode, the encoding process may involve dividing the line corresponding to the dominant eigenvector (i.e., principal component) into bins based on the minimum and maximum color values of the pixel block and a particular number of bits assigned to the encoding process. Then, each pixel in the pixel block (e.g., in the three-dimensional RGB coordinate space) may be projected onto the line and encoded based on the bin that the projection falls into. Each bin is associated with a single quantized value falling on the single-dimensional line corresponding to the dominant eigenvector. For example, referring to the coordinate system 4510 in FIG. 16, the color values of a pixel block are illustrated as having strong color correspondences such that a line drawn through the pixels (e.g., dominant eigenvector) sufficiently represents the distribution of the pixel color values in the dataset. In the embodiment illustrated in FIG. 16, the encoding process is assigned 3 binary bits to represent the bins, thus, as illustrated in the coordinate system 4520, the line is divided into 8 bins since 3 bits are able to represent 8 different values. The first bin is illustrated as corresponding the minimum value of the pixel values in the pixel block (e.g., minimum pixel value [32, 22, 12]), and the last bin is illustrated as corresponding to the maximum value of the pixel values in the pixel block (e.g., maximum pixel value [66, 53, 42]). In particular embodiments, the number of bits assigned to the encoding process may be determined based on the range of the pixel values corresponding to a particular color channel. For example, if the range of red pixel values in the block is 20 (e.g., minimum pixel value of 100; maximum pixel value of 120), the pixels may be encoded using 5 bits since 5 bits are able to represent 32 different values. In some embodiments, the number of bits assigned to the encoding process may be determined based on the average range of the pixel values corresponding to two or three color channels. In other embodiments, the number of bits assigned to the encoding process may be determined based on a target compression ratio for the pixel block (e.g., 3 bits).

In particular embodiments, the decoding process involves identifying the bin that the pixel was encoded based upon and the associated quantized value of the bin, which corresponds to the one-dimensional coordinate space of the dominant eigenvector, then determining the three-dimensional point in the RGB coordinate space that corresponds to the quantized value of the bin. In some embodiments, the RGB color values corresponding to each bin may be indexed in a look-up table, allowing the RGB color values to be determined based on thereof.

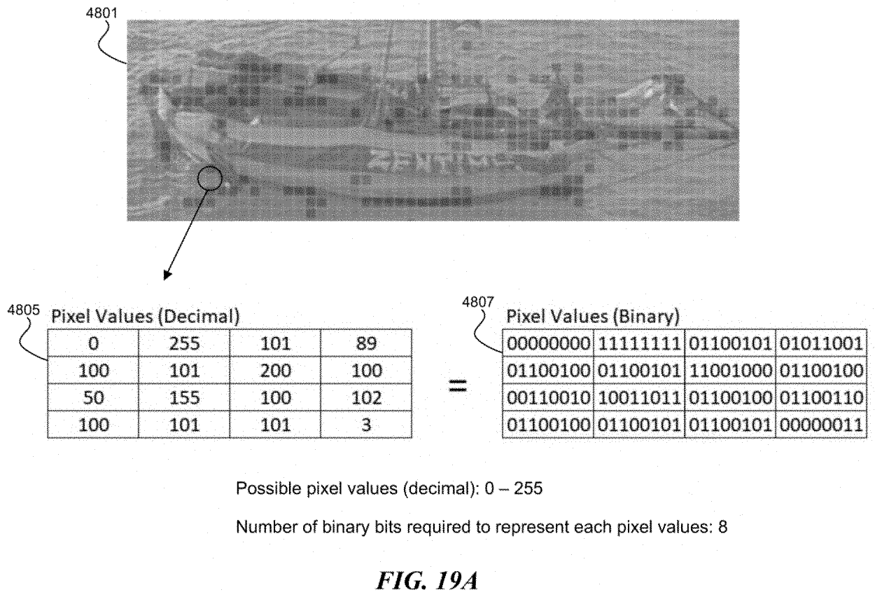

FIG. 17 illustrates an example image 4600 comprising a plurality of pixel blocks that are selectively encoded using the joint-color mode. The lighter pixel blocks correspond to blocks with sufficiently high RGB color correspondences, thus may be encoded using the joint-color mode where the color values of the pixels are jointly encoded based on PCA. The darker pixel blocks correspond to blocks without sufficiently high RGB color correspondence, thus may be encoded using a standard encoding mode where the color values for each of the color channels are encoded separately. As discussed above, pixel blocks may be encoded using the joint-color mode if there are strong correspondences between the RGB color values in the pixel block. However, in some embodiment, pixel blocks may not be encoded with the joint-color mode even if the color values of the block are highly correlated to each other, because the joint-color mode may not be able to accurately represent the color information of the block, thereby producing undesirable artifacts when the block is decoded.

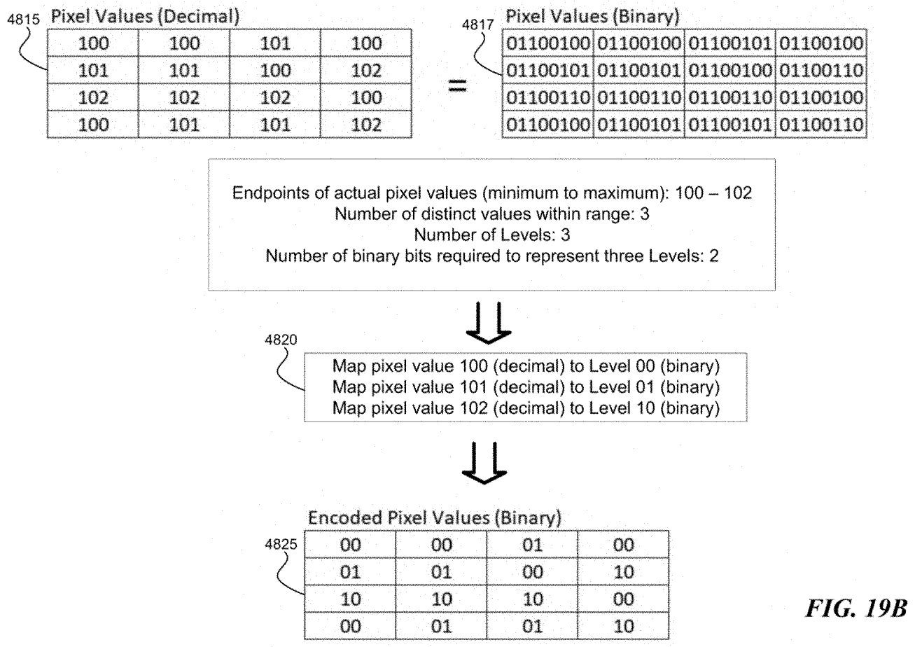

FIG. 18 illustrates an example image 4710 comprising darker pixel blocks corresponding to the edges of the trees. Those darker pixels were determined as having sufficiently high RGB color correspondences, thus were encoded using the joint-color mode. However, as it can be seen in the decoded image 4715, undesirable artifacts can be seen by the outer-edges of the trees. Such undesirable artifacts may be produced if pixel blocks comprising over-exposed pixels or high-contrast pixels are encoded using the joint-color mode. Examples of high-contrast pixels are shown in the image 4715 (e.g., the edges of the trees indicated by the illustrated box). Thus, in particular embodiments, even if the color values of the block are highly correlated to each other, certain pixel blocks may be encoded using the standard encoding mode, for example, if the color range of the pixels is greater than a threshold value (to detect high-contrast edges) or if there are a group of over-exposed pixels (e.g., a group of pixels with value of pixel value 4255). A demonstration of this technique is illustrated in images 4720 and 4725 where the edges of the trees do not display any undesirable artifacts.

In particular embodiments, pixel blocks may be encoded using joint-color mode even when not all the components of pixel data are available (e.g., even when the pixel data for the red channel is unavailable). Cross-channel Convolution Filter (CCF) is one example where one or more color components might be unavailable. CCF, which helps to suppress chromatic aliasing artifacts using 4 μm red μLED with 2 μm green and blue μLEDs, utilizes a set of cross-channel convolution filters to be applied to input streams prior to MIP generation. Each color channel requires three 3×3 convolution filter operations. At certain MIP levels (e.g., MIP 0 and the max MIP), not all color channels might be present. When one or more color channels are unavailable, one option is to disable the joint-color encoding scheme described above, but doing so could be inefficient when the available channels are actually highly correlated.

In embodiments where joint-color encoding continues to be used when one or more color channels are unavailable, one of two method may be used. In one method, which may be referred to as “zero mode,” a channel of pixel data that is unavailable may be given zero values. For example, if the red pixel data is not available, each red pixel may be assigned with the value of 0. In another method, which may be referred to as “copy mode,” a channel of pixel data that is unavailable may be duplicated from another channel's pixel data. For example, if red pixel data is not available in RGB pixel data, the red pixels may be duplicated from either the green pixel data or the blue pixel data. The channel that pixel data is duplicated from may be determined based on the energy of the channels. In an embodiment, if there are two channels of pixel data that are unavailable, copy mode may not be used, rather the single channel of available pixel data may be encoded independently. In an embodiment, the copy mode may use a buffer pointer to assign pixel data, rather than directly copying the data. The result of applying zero mode or copy mode is that the missing color channel information is filled. With all color channels available, the joint-color encoding scheme described elsewhere herein may continue to be used to efficiently encode channels that are highly correlated.

Now being described is a compression technique referred to as the adaptive range packing technique which involves compressing various types of pixel data into two-dimensional arrays of values. For example, the adaptive range packing technique may be used to compress types of data corresponding to image colors, depth, and motion or optical flow. In particular embodiments, the adaptive range packing technique aims to compress pixel data by a constant rate, such that the amount of compression resulting from the technique results in, on average, a predictable and substantially constant rate. In some embodiments, the adaptive range packing technique may involve variable rate compression.

In particular embodiments, an image may be partitioned into a plurality of blocks, each block comprising a plurality of pixels. Depending on the type of data associated with the image, each pixel may have multiple components or channels. For example, if the type of data corresponds to color values, each pixel may be associated with a number of components such as the red, blue, and green components for RGB colors, Cb and Cr components for chrominance, or Y component for luminance. If the type of data corresponds to motion, each pixel may be associated with components corresponding to motion vector/field or optical flow vector/field. If the type of data corresponds to depth, each pixel may be associated with a depth component (e.g., z value). The adaptive range packing technique described herein, while capable of encoding the various pixel components, such as those described above, each component is encoded separately.

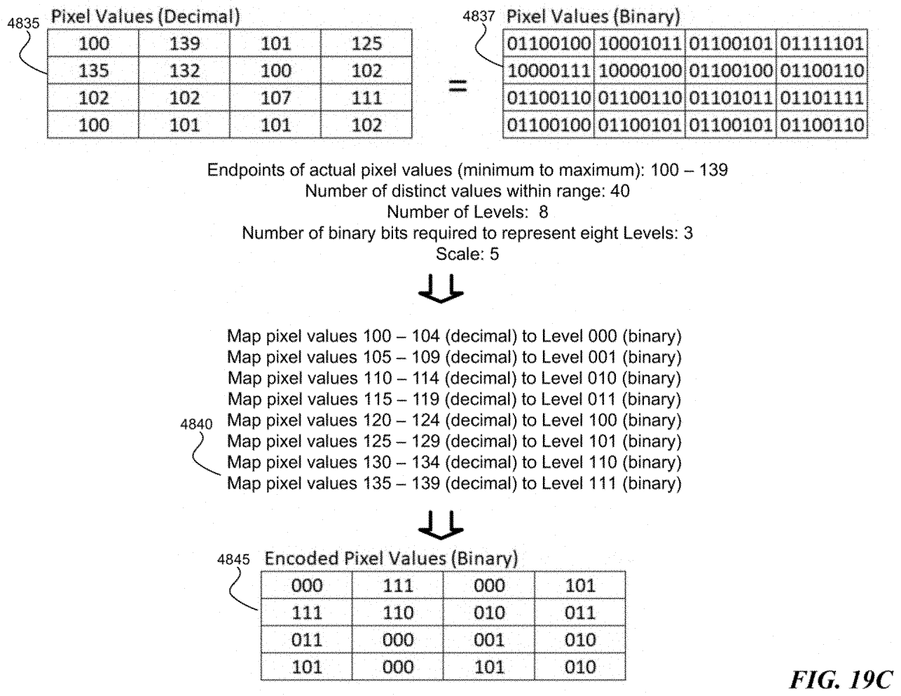

FIGS. 19A-19C illustrate diagrams and data arrays demonstrating the adaptive range packing technique of this disclosure. As illustrated in FIG. 19A, an image 4801 may be partitioned into a plurality of pixel blocks (e.g., pixel arrays) of a particular size. In particular embodiments, the size of the pixel block may be determined based on the variance of the pixel values in the block (e.g., 4×4, 16×16, etc.). The compression ratio resulting from the adaptive range packing technique improves as the variance of the pixel values decreases. Thus, if an image is associated with high variance of pixel values, the image may be partitioned into smaller pixel blocks to reduce the variance contained in each pixel block, thereby improving the compression ratio. Alternatively, if the image is associated with low variance of pixel values, the image may be partitioned into bigger pixel blocks to improve the compression ratio. While the embodiments illustrated in FIGS. 19A-19C show examples of 4×4 pixel arrays, this disclosure contemplates any size of pixel arrays that is suitable for improving the compression ratio.

FIG. 19A illustrates an example of uncompressed pixel arrays 4805 and 4807 that may be representative of the pixel values of a block of a particular image (e.g., image 4801). Typically, the pixel range of the RGB color values corresponds to the minimum value of 0 and the maximum value of 255 (e.g., 256 total color values), which may be represented by 8 binary bits. For example, the pixel array 4805 shows sixteen pixel values ranging from 0 to 255. The pixel array 807 shows binary representations of pixel values shown in the pixel array 4805.

FIG. 19B illustrates example pixel arrays demonstrating the lossless variation of the adaptive range packing technique. The adaptive range packing technique leverages the similarities between the pixel values within a pixel block to represent the pixel values with reduced number of binary bits. The technique involves determining the range of the pixel values in a block and the endpoints of the pixel values, then determining the quantization levels to represent the values within the pixel range. In some embodiments, the adaptive range packing technique compresses a pixel block in a lossless fashion such that each distinct value within the pixel range is represented by a quantization level. For example, in reference to the pixel array 815, given that there are three distinct pixel values (i.e., 100, 101, 102), three quantization levels are assigned, one for each distinct pixel value, as shown in the table 4820. Converting each pixel value in the pixel array 4815 based on the table 4820 involves mapping each pixel values to their corresponding quantization level, which results in the compressed pixel array 4825. This allows each of the pixel values to be represented by 2 binary bits instead of the 8 binary bits shown in the uncompressed pixel array 4817. In accordance to some embodiments, the decoding process involves adding the encoded pixel values to the minimum pixel value of the uncompressed pixel array (e.g., pixel array 4815).

FIG. 19C illustrates example pixel arrays demonstrating the lossy variation of the adaptive range packing technique. In some embodiments, the adaptive range packing technique may compress the pixel block in a lossy fashion such that each quantization level represents a group of discrete values. In contrast to the lossless variation, the number of quantization levels representing the values within the pixel range is less than the number of discrete values within the pixel range. In such embodiments, the number of quantization levels may be predetermined prior to the encoding process, or alternatively, dynamically calculated to ensure that the image, or each individual pixel block within the image, is compressed at a particular compression ratio. In reference to the pixel array 4835, eight levels have been assigned to represent forty distinct pixel values, each level representing five distinct pixel values, as indicated by the scale value of 5. This allows each of the pixel values in the pixel array 4835 to be represented by one of the eight assigned levels, in accordance to the table 4820. Pixel values that are encoded based on the table 4820 are shown in the encoded pixel array 4845. As shown in the pixel array 4845, each pixel value is represented by 3 binary bits instead of the 8 binary bits shown in the uncompressed pixel array 4837. In accordance to some embodiments, the decoding process involves multiplying the encoded pixel values by the scale then adding them to the minimum pixel value of the uncompressed pixel array (e.g., pixel array 4835).

In particular embodiments, where the number of the quantization levels assigned to a pixel block corresponds an uneven number, multiple pixel values may be grouped together and represented by a longer bit string to better utilize the bits. For example, referring to the table 4820 in FIG. 19B, pixel range of three (e.g., three distinct values of the pixels), or three quantization levels, are represented by two binary bits. However, each of the two bits are under-utilized since two bits being are being used to represent three values when they are capable of representing four values. In such embodiments, multiple pixel values may be grouped together and represented by a longer bit string based on the unique combination resulting from grouping of the pixel values. For example, referring back to FIG. 19B, if five pixel values are grouped together, given that the number of levels assigned to each pixel value is three (e.g., three distinct values, or the range of pixel values being three), there would be 243 possible combinations of values resulting from the grouping of the pixel values (e.g., 3*3*3*3*3=3^5=243). These unique combination of values could be represented by 8 binary bits since 8 bits are capable of representing 256 different values. Therefore, each grouping of five pixel values in the pixel array 4825 (e.g., [00, 00, 01, 00, 01]) can be classified based on the unique combination of the pixel values and mapped to an 8 binary bit value representing the unique combination. This means that the pixel array 4825, which comprises 16 pixel values represented by 32 binary bits, could be compressed even further by utilizing three 8 binary bit strings to represent 15 pixel values and one additional 2 binary bit string to represent the last pixel value, totaling the use of 26 binary bits to represent 16 pixel values. Similar approach could be employed whenever the range of pixel values can be factored into powers of 2, 3, or 5. For example, if the range is 9, which can be factored as 3*3, then each pixel value can be represented by two base-3 digits. The number of bits required to represent 16 pixel values, X, can be solved by the equation X=A*3+B, where A and B are each one of base-3 digits: {0,1,2}. Given that A=X/3 has a range of 3 and B=X−A*3 also has a range of 3, each of the 16 values of A and B can be encoded into 26 bits. Then, the total number of bits required to represent 16 pixel values, with the pixel range of 9, can be solved as 52 bits. If the range is 45, which can be factored as 3*3*5, then the number of bits required to represent 16 pixel values, X, can be solved by the equation X=5*AB+C, where A and B are each one of base-3 digits and C is a base-5 digit. Three different C values could be represented in 7 bits since there would be 125 possible combinations of values resulting from the grouping of the pixel values (e.g., 5*5*5=5^3=125), which is less than the 128 values represented by 7 binary bits. Five of these 7-bit strings could represent 15 of the of the 16 total pixel values, and the last pixel value could be represented by 3 bits, meaning C value in the equation can be solved to 38 bits (e.g., five 7-bit string with 3 additional bits). From the above example, AB was determined as requiring 52 bits, which can be added to the 38 bits required for the C value, resulting in 90 bits for X, which represents the total number of bits required to represent 16 pixel values with the pixel range of 45.

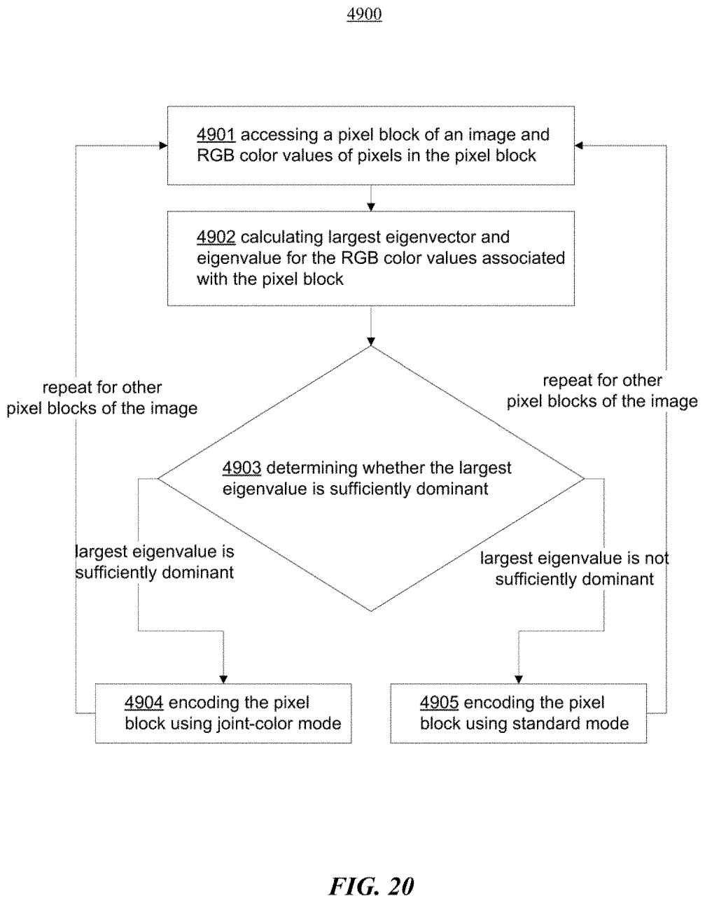

FIG. 20 illustrates an example method 4900 for selectively encoding pixel blocks of an image based on joint-color mode. The method may begin at step 4901 by accessing a pixel block of an image and RGB color values of the pixels in the pixel block. At step 4902, the method may continue by calculating the largest eigenvectors and eigenvalues for the RGB color values associated with the pixel block. At step 4903, the method may continue by determining whether the largest eigenvalue is sufficiently dominant. If the largest eigenvalue is sufficiently dominant, at step 4904, the method may continue by encoding the pixel block using joint-color mode. If the largest eigenvalue is not sufficiently dominant, at step 4905, the method may continue by encoding the pixel block using standard mode. Then, the method 4900 may repeat for other pixel blocks of the image until all of the pixel blocks of the image are encoded either by the joint-color mode or the standard mode. Particular embodiments may repeat one or more steps of the method of FIG. 20, where appropriate. Although this disclosure describes and illustrates particular steps of the method of FIG. 20 as occurring in a particular order, this disclosure contemplates any suitable steps of the method of FIG. 20 occurring in any suitable order. Moreover, although this disclosure describes and illustrates an example method for selectively encoding pixel blocks of an image based on joint-color mode, this disclosure contemplates any suitable method for selectively encoding pixel blocks of an image based on joint-color mode including any suitable steps, which may include all, some, or none of the steps of the method of FIG. 20, where appropriate. Furthermore, although this disclosure describes and illustrates particular components, devices, or systems carrying out particular steps of the method of FIG. 20, this disclosure contemplates any suitable combination of any suitable components, devices, or systems carrying out any suitable steps of the method of FIG. 20.

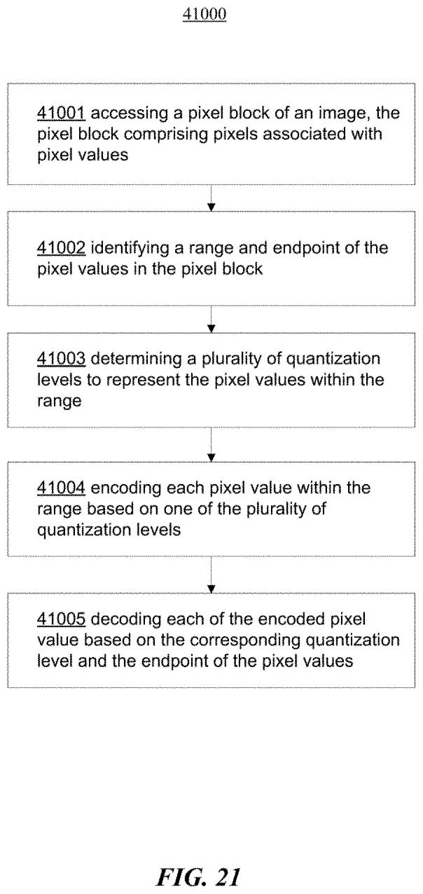

FIG. 21 illustrates an example method 41000 for compressing and decompressing pixel arrays based on quantization levels. The method may begin at step 41001 by accessing a pixel block of an image, the pixel block comprising pixels associated with pixel values. At step 41002, the method may continue by identifying a range and endpoint of the pixel values in the pixel block. At step 41003, the method may continue by determining a plurality of quantization levels to represent the pixel values within the range. At step 41004, the method may continue by encoding each pixel value within the range based on one of the plurality of quantization levels. At step 41005, the method 41000 may also include the steps of decompressing the pixel array by decoding each of the encoded pixel value based on the corresponding quantization level and the endpoint of the pixel values. Particular embodiments may repeat one or more steps of the method of FIG. 21, where appropriate. Although this disclosure describes and illustrates particular steps of the method of FIG. 21 as occurring in a particular order, this disclosure contemplates any suitable steps of the method of FIG. 21 occurring in any suitable order. Moreover, although this disclosure describes and illustrates an example method for compressing and decompressing pixel arrays based on quantization levels, this disclosure contemplates any suitable method for compressing and decompressing pixel arrays based on quantization levels including any suitable steps, which may include all, some, or none of the steps of the method of FIG. 21, where appropriate. Furthermore, although this disclosure describes and illustrates particular components, devices, or systems carrying out particular steps of the method of FIG. 21, this disclosure contemplates any suitable combination of any suitable components, devices, or systems carrying out any suitable steps of the method of FIG. 21.

### Network Environment

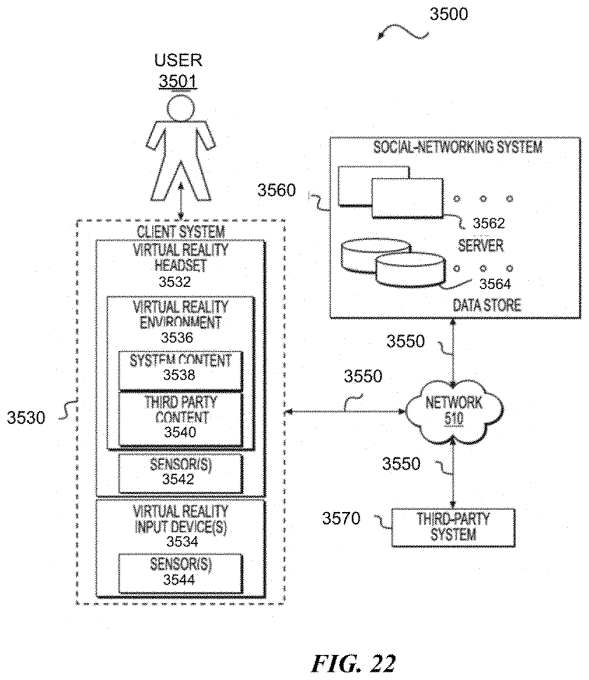

FIG. 22 illustrates an example network environment 3500 associated with a virtual reality system. Network environment 3500 includes a user 3501 interacting with a client system 3530, a social-networking system 3560, and a third-party system 3570 connected to each other by a network 3510. Although FIG. 5 illustrates a particular arrangement of a user 3501, a client system 3530, a social-networking system 3560, a third-party system 3570, and a network 3510, this disclosure contemplates any suitable arrangement of a user 3501, a client system 3530, a social-networking system 3560, a third-party system 3570, and a network 3510. As an example, and not by way of limitation, two or more of users 3501, a client system 3530, a social-networking system 3560, and a third-party system 3570 may be connected to each other directly, bypassing a network 3510. As another example, two or more of client systems 3530, a social-networking system 3560, and a third-party system 3570 may be physically or logically co-located with each other in whole or in part. Moreover, although FIG. 5 illustrates a particular number of users 3501, client systems 3530, social-networking systems 3560, third-party systems 3570, and networks 3510, this disclosure contemplates any suitable number of client systems 3530, social-networking systems 3560, third-party systems 3570, and networks 3510. As an example, and not by way of limitation, network environment 3500 may include multiple users 3501, client systems 3530, social-networking systems 3560, third-party systems 3570, and networks 3510. This disclosure contemplates any suitable network 3510. As an example, and not by way of limitation, one or more portions of a network 3510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 3510 may include one or more networks 3510. Links 3550 may connect a client system 3530, a social-networking system 3560, and a third-party system 3570 to a communication network 3510 or to each other. This disclosure contemplates any suitable links 3550. In particular embodiments, one or more links 3550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 3550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 3550, or a combination of two or more such links 3550. Links 3550 need not necessarily be the same throughout a network environment 3500. One or more first links 3550 may differ in one or more respects from one or more second links 3550.

In particular embodiments, a client system 3530 may be an electronic device including hardware, software, or embedded logic components or a combination of two or more such components and capable of carrying out the appropriate functionalities implemented or supported by a client system 3530. As an example, and not by way of limitation, a client system 3530 may include a computer system such as a desktop computer, notebook or laptop computer, netbook, a tablet computer, e-book reader, GPS device, camera, a digital assistant (PDA), handheld electronic device, cellular telephone, smartphone, virtual reality headset and controllers, other suitable electronic device, or any suitable combination thereof. This disclosure contemplates any suitable client systems 3530. A client system 3530 may enable a network user at a client system 3530 to access a network 3510. A client system 3530 may enable its user to communicate with other users at other client systems 3530. A client system 3530 may generate a virtual reality environment for a user to interact with content.

In particular embodiments, a client system 3530 may include a virtual reality (or augmented reality) headset 3532, and virtual reality input device(s) 3534, such as a virtual reality controller. A user at a client system 3530 may wear the virtual reality headset 3532 and use the virtual reality input device(s) to interact with a virtual reality environment 3536 generated by the virtual reality headset 3532. Although not shown, a client system 3530 may also include a separate processing computer and/or any other component of a virtual reality system. A virtual reality headset 3532 may generate a virtual reality environment 3536, which may include system content 3538 (including but not limited to the operating system), such as software or firmware updates and also include third-party content 3540, such as content from applications or dynamically downloaded from the Internet (e.g., web page content). A virtual reality headset 3532 may include sensor(s) 3542, such as accelerometers, gyroscopes, magnetometers to generate sensor data that tracks the location of the headset device 3532. The headset 3532 may also include eye trackers for tracking the position of the user's eyes or their viewing directions. The client system may use data from the sensor(s) 3542 to determine velocity, orientation, and gravitation forces with respect to the headset.

Virtual reality input device(s) 3534 may include sensor(s) 3544, such as accelerometers, gyroscopes, magnetometers, and touch sensors to generate sensor data that tracks the location of the input device 3534 and the positions of the user's fingers. The client system 3530 may make use of outside-in tracking, in which a tracking camera (not shown) is placed external to the virtual reality headset 3532 and within the line of sight of the virtual reality headset 3532. In outside-in tracking, the tracking camera may track the location of the virtual reality headset 3532 (e.g., by tracking one or more infrared LED markers on the virtual reality headset 3532). Alternatively, or additionally, the client system 3530 may make use of inside-out tracking, in which a tracking camera (not shown) may be placed on or within the virtual reality headset 3532 itself In inside-out tracking, the tracking camera may capture images around it in the real world and may use the changing perspectives of the real world to determine its own position in space.

Third-party content 3540 may include a web browser, and may have one or more add-ons, plug-ins, or other extensions. A user at a client system 3530 may enter a Uniform Resource Locator (URL) or other address directing a web browser to a particular server (such as server 3562, or a server associated with a third-party system 3570), and the web browser may generate a Hyper Text Transfer Protocol (HTTP) request and communicate the HTTP request to server. The server may accept the HTTP request and communicate to a client system 3530 one or more Hyper Text Markup Language (HTML) files responsive to the HTTP request. The client system 3530 may render a web interface (e.g., a webpage) based on the HTML files from the server for presentation to the user. This disclosure contemplates any suitable source files. As an example, and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, SILVERL1GHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 3560 may be a network-addressable computing system that may host an online social network. The social-networking system 3560 may generate, store, receive, and send social-networking data, such as, for example, user-profile data, concept-profile data, social-graph information, or other suitable data related to the online social network. The social-networking system 3560 may be accessed by the other components of network environment 3500 either directly or via a network 3510. As an example, and not by way of limitation, a client system 3530 may access the social-networking system 3560 using a web browser of a third-party content 3540, or a native application associated with the social-networking system 3560 (e.g., a mobile social-networking application, a messaging application, another suitable application, or any combination thereof) either directly or via a network 5310. In particular embodiments, the social-networking system 3560 may include one or more servers 3562. Each server 3562 may be a unitary server or a distributed server spanning multiple computers or multiple datacenters. Servers 3562 may be of various types, such as, for example and without limitation, web server, news server, mail server, message server, advertising server, file server, application server, exchange server, database server, proxy server, another server suitable for performing functions or processes described herein, or any combination thereof.

In particular embodiments, each server 3562 may include hardware, software, or embedded logic components or a combination of two or more such components for carrying out the appropriate functionalities implemented or supported by server 3562. In particular embodiments, the social-networking system 3560 may include one or more data stores 3564. Data stores 3564 may be used to store various types of information. In particular embodiments, the information stored in data stores 3564 may be organized according to specific data structures. In particular embodiments, each data store 3564 may be a relational, columnar, correlation, or other suitable database. Although this disclosure describes or illustrates particular types of databases, this disclosure contemplates any suitable types of databases. Particular embodiments may provide interfaces that enable a client system 3530, a social-networking system 3560, or a third-party system 3570 to manage, retrieve, modify, add, or delete, the information stored in data store 3564.

In particular embodiments, the social-networking system 3560 may store one or more social graphs in one or more data stores 3564. In particular embodiments, a social graph may include multiple nodes—which may include multiple user nodes (each corresponding to a particular user) or multiple concept nodes (each corresponding to a particular concept)—and multiple edges connecting the nodes. The social-networking system 3560 may provide users of the online social network the ability to communicate and interact with other users. In particular embodiments, users may join the online social network via the social-networking system 3560 and then add connections (e.g., relationships) to a number of other users of the social-networking system 3560 whom they want to be connected to. Herein, the term “friend” may refer to any other user of the social-networking system 3560 with whom a user has formed a connection, association, or relationship via the social-networking system 3560.

In particular embodiments, the social-networking system 3560 may provide users with the ability to take actions on various types of items or objects, supported by the social-networking system 3560. As an example, and not by way of limitation, the items and objects may include groups or social networks to which users of the social-networking system 3560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 3560 or by an external system of a third-party system 3570, which is separate from the social-networking system 3560 and coupled to the social-networking system 3560 via a network 3510.

In particular embodiments, the social-networking system 3560 may be capable of linking a variety of entities. As an example, and not by way of limitation, the social-networking system 3560 may enable users to interact with each other as well as receive content from third-party systems 3570 or other entities, or to allow users to interact with these entities through an application programming interfaces (API) or other communication channels. In particular embodiments, a third-party system 3570 may include one or more types of servers, one or more data stores, one or more interfaces, including but not limited to APIs, one or more web services, one or more content sources, one or more networks, or any other suitable components, e.g., that servers may communicate with. A third-party system 3570 may be operated by a different entity from an entity operating the social-networking system 3560. In particular embodiments, however, the social-networking system 3560 and third-party systems 3570 may operate in conjunction with each other to provide social-networking services to users of the social-networking system 3560 or third-party systems 3570. In this sense, the social-networking system 3560 may provide a platform, or backbone, which other systems, such as third-party systems 3570, may use to provide social-networking services and functionality to users across the Internet.

In particular embodiments, a third-party system 3570 may include a third-party content object provider. A third-party content object provider may include one or more sources of content objects, which may be communicated to a client system 3530. As an example, and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 3560 also includes user-generated content objects, which may enhance a user's interactions with the social-networking system 3560. User-generated content may include anything a user may add, upload, send, or “post” to the social-networking system 3560. As an example, and not by way of limitation, a user communicates posts to the social-networking system 3560 from a client system 3530. Posts may include data such as status updates or other textual data, location information, photos, videos, links, music or other similar data or media. Content may also be added to the social-networking system 3560 by a third-party through a “communication channel,” such as a newsfeed or stream. In particular embodiments, the social-networking system 3560 may include a variety of servers, sub-systems, programs, modules, logs, and data stores. In particular embodiments, the social-networking system 3560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 3560 may also include suitable components such as network interfaces, security mechanisms, load balancers, failover servers, management-and-network-operations consoles, other suitable components, or any suitable combination thereof.

In particular embodiments, the social-networking system 3560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example, and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 3560 to one or more client systems 3530 or one or more third-party systems 3570 via a network 3510. The web server may include a mail server or other messaging functionality for receiving and routing messages between the social-networking system 3560 and one or more client systems 3530. An API-request server may allow a third-party system 3570 to access information from the social-networking system 3560 by calling one or more APIs. An action logger may be used to receive communications from a web server about a user's actions on or off the social-networking system 3560.

In conjunction with the action log, a third-party-content-object log may be maintained of user exposures to third-party-content objects. A notification controller may provide information regarding content objects to a client system 3530. Information may be pushed to a client system 3530 as notifications, or information may be pulled from a client system 3530 responsive to a request received from a client system 3530. Authorization servers may be used to enforce one or more privacy settings of the users of the social-networking system 3560. A privacy setting of a user may determine how particular information associated with a user may be shared. The authorization server may allow users to opt in to or opt out of having their actions logged by the social-networking system 3560 or shared with other systems (e.g., a third-party system 3570), such as, for example, by setting appropriate privacy settings. Third-party-content-object stores may be used to store content objects received from third parties, such as a third-party system 3570. Location stores may be used for storing location information received from client systems 3530 associated with users. Advertisement-pricing modules may combine social information, the current time, location information, or other suitable information to provide relevant advertisements, in the form of notifications, to a user.

### Computer System

FIG. 7 illustrates an example computer system 5700. In particular embodiments, one or more computer systems 5700 perform one or more steps of one or more methods described or illustrated herein. In particular embodiments, one or more computer systems 5700 provide functionality described or illustrated herein. In particular embodiments, software running on one or more computer systems 5700 performs one or more steps of one or more methods described or illustrated herein or provides functionality described or illustrated herein. Particular embodiments include one or more portions of one or more computer systems 5700. Herein, reference to a computer system may encompass a computing device, and vice versa, where appropriate. Moreover, reference to a computer system may encompass one or more computer systems, where appropriate.

This disclosure contemplates any suitable number of computer systems 5700. This disclosure contemplates computer system 5700 taking any suitable physical form. As example and not by way of limitation, computer system 5700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 5700 may include one or more computer systems 5700; be unitary or distributed; span multiple locations; span multiple machines; span multiple data centers; or reside in a cloud, which may include one or more cloud components in one or more networks. Where appropriate, one or more computer systems 5700 may perform without substantial spatial or temporal limitation one or more steps of one or more methods described or illustrated herein. As an example and not by way of limitation, one or more computer systems 5700 may perform in real time or in batch mode one or more steps of one or more methods described or illustrated herein. One or more computer systems 5700 may perform at different times or at different locations one or more steps of one or more methods described or illustrated herein, where appropriate.

In particular embodiments, computer system 5700 includes a processor 5702, memory 5704, storage 5706, an input/output (I/O) interface 5708, a communication interface 55712, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 5702 includes hardware for executing instructions, such as those making up a computer program. As an example and not by way of limitation, to execute instructions, processor 5702 may retrieve (or fetch) the instructions from an internal register, an internal cache, memory 5704, or storage 5706; decode and execute them; and then write one or more results to an internal register, an internal cache, memory 5704, or storage 5706. In particular embodiments, processor 5702 may include one or more internal caches for data, instructions, or addresses. This disclosure contemplates processor 5702 including any suitable number of any suitable internal caches, where appropriate. As an example and not by way of limitation, processor 5702 may include one or more instruction caches, one or more data caches, and one or more translation lookaside buffers (TLBs). Instructions in the instruction caches may be copies of instructions in memory 5704 or storage 5706, and the instruction caches may speed up retrieval of those instructions by processor 5702. Data in the data caches may be copies of data in memory 5704 or storage 5706 for instructions executing at processor 5702 to operate on; the results of previous instructions executed at processor 5702 for access by subsequent instructions executing at processor 5702 or for writing to memory 5704 or storage 5706; or other suitable data. The data caches may speed up read or write operations by processor 5702. The TLBs may speed up virtual-address translation for processor 5702. In particular embodiments, processor 5702 may include one or more internal registers for data, instructions, or addresses. This disclosure contemplates processor 5702 including any suitable number of any suitable internal registers, where appropriate. Where appropriate, processor 5702 may include one or more arithmetic logic units (ALUs); be a multi-core processor; or include one or more processors 5702. Although this disclosure describes and illustrates a particular processor, this disclosure contemplates any suitable processor.

In particular embodiments, memory 5704 includes main memory for storing instructions for processor 5702 to execute or data for processor 5702 to operate on. As an example and not by way of limitation, computer system 5700 may load instructions from storage 5706 or another source (such as, for example, another computer system 5700) to memory 5704. Processor 5702 may then load the instructions from memory 5704 to an internal register or internal cache. To execute the instructions, processor 5702 may retrieve the instructions from the internal register or internal cache and decode them. During or after execution of the instructions, processor 5702 may write one or more results (which may be intermediate or final results) to the internal register or internal cache. Processor 5702 may then write one or more of those results to memory 5704. In particular embodiments, processor 5702 executes only instructions in one or more internal registers or internal caches or in memory 5704 (as opposed to storage 5706 or elsewhere) and operates only on data in one or more internal registers or internal caches or in memory 5704 (as opposed to storage 5706 or elsewhere). One or more memory buses (which may each include an address bus and a data bus) may couple processor 5702 to memory 5704. Bus 712 may include one or more memory buses, as described below. In particular embodiments, one or more memory management units (MMUs) reside between processor 5702 and memory 5704 and facilitate accesses to memory 5704 requested by processor 5702. In particular embodiments, memory 5704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 5704 may include one or more memories 5704, where appropriate. Although this disclosure describes and illustrates particular memory, this disclosure contemplates any suitable memory.

In particular embodiments, storage 5706 includes mass storage for data or instructions. As an example and not by way of limitation, storage 5706 may include a hard disk drive (HDD), a floppy disk drive, flash memory, an optical disc, a magneto-optical disc, magnetic tape, or a Universal Serial Bus (USB) drive or a combination of two or more of these. Storage 5706 may include removable or non-removable (or fixed) media, where appropriate. Storage 5706 may be internal or external to computer system 5700, where appropriate. In particular embodiments, storage 5706 is non-volatile, solid-state memory. In particular embodiments, storage 5706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 5706 taking any suitable physical form. Storage 5706 may include one or more storage control units facilitating communication between processor 5702 and storage 5706, where appropriate. Where appropriate, storage 5706 may include one or more storages 5706. Although this disclosure describes and illustrates particular storage, this disclosure contemplates any suitable storage.

In particular embodiments, I/O interface 5708 includes hardware, software, or both, providing one or more interfaces for communication between computer system 5700 and one or more I/O devices. Computer system 5700 may include one or more of these I/O devices, where appropriate. One or more of these I/O devices may enable communication between a person and computer system 5700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 5708 for them. Where appropriate, I/O interface 5708 may include one or more device or software drivers enabling processor 5702 to drive one or more of these I/O devices. I/O interface 5708 may include one or more I/O interfaces 5708, where appropriate. Although this disclosure describes and illustrates a particular I/O interface, this disclosure contemplates any suitable I/O interface.

In particular embodiments, communication interface 55712 includes hardware, software, or both providing one or more interfaces for communication (such as, for example, packet-based communication) between computer system 5700 and one or more other computer systems 5700 or one or more networks. As an example and not by way of limitation, communication interface 55712 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 55712 for it. As an example and not by way of limitation, computer system 5700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 5700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 5700 may include any suitable communication interface 55712 for any of these networks, where appropriate. Communication interface 55712 may include one or more communication interfaces 55712, where appropriate. Although this disclosure describes and illustrates a particular communication interface, this disclosure contemplates any suitable communication interface.

In particular embodiments, bus 712 includes hardware, software, or both coupling components of computer system 5700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
determining a first display content to be displayed on a display, wherein the first display content is associated with one or more frames;
determining an optimization operation for the first display content based on one or more first parameters associated with the display or one or more second parameters associated with the one or more frames;
adjusting the one or more frames based on the optimization operation, wherein the adjusted one or more frames have at least one optimized attribute comparing to the one or more frames before being adjusted; and
outputting the adjusted one or more frames to the display to represent the first display content.

2. The method of claim 1, wherein the optimization operation comprises:
determining, an attenuation function that decreases in at least a portion of a pre-determined range;
determining a scaling factor for each pixel of each color channel for each frame to be displayed based on the attenuation function;
applying the scaling factors to pixel values of that frame to be displayed to adjust the pixel values of that frame; and
outputting the adjusted pixel values of that frame to the display, wherein the displayed frames has a fade-away effect from a center portion toward edge portions of the display,
wherein the scaling factors for RGB color channels are incorporated into respective non-uniformity correction matrixes of RGB color channels, wherein the display is associated with an octagonal view port, wherein the octagonal view port has smoothed edge areas with the fade-away effect, and wherein the attenuation function and the scaling factors are based on one or more characteristics of an associated waveguide for that color channel.

3. The method of claim 1, wherein the optimization operation comprises:
determining an amount of computation that is used for rendering a previous frame;
determining an increase or decrease in the amount of computation for a current frame;
determining a current amount of computation by adjusting the amount of computation that is used for rendering the previous frame based on the increase or decrease in the amount of computation for a current frame;
comparing the current amount of computation to one or more thresholds; and
based on the comparison of the current amount of computation for the current frame and the one or more thresholds, adjusting a computational capacity level, wherein the computational capacity level is adjusted by:
turning on an extra processing unit in addition to a current operating processing unit;
increasing an operating voltage and frequency of the current operating processing units; or
adjusting a foveated rendering ratio to adjust the amount of computation for the current frame.

4. The method of claim 1, further comprising:
accessing a first pixel block of a frame of the one or more frames, the first pixel block comprising pixels that are each associated with three color values;
determining that first color values of the three color values is not available for the pixels of the first pixel block, and in response:
assigning a zero value to each first color value of the pixels of the first pixel block; or
assigning a duplicated value to each first color value of the pixels of the first pixel block based on a corresponding second color value of the three color values or a corresponding third color value of the three color values;
determining whether to separately encode or jointly encode the three color values of each of the pixels of the first pixel block;
determining that the three color values of each of the pixels in the first pixel block are to be jointly encoded based on:
determining, based on the three color values of each of the pixels of the first pixel block, a line defined within a three-dimensional coordinate system in which each of the pixels is represented as a three-dimensional point; and
determining that the line satisfies one or more predetermined criteria; and
encoding the three color values of each of the pixels in the first pixel block as a single quantized value based on a projection of the three-dimensional point associated with that pixel onto the line.

5. A device comprising:
a controller configured to regulate one or more voltages applied to a gate of a transistor, the controller further configured to:
generate a gating signal and transmit the gating signal to the transistor, wherein the gating signal comprises a pulse width modulation (PWM) signal configured to activate or deactivate the transistor; and
modulate the PWM signal and transmit the modulated PWM signal to control an activation period or deactivation period of the transistor, wherein modulating the PWM signal comprises altering a duty cycle of the PWM signal over a predetermined time interval, such that the activation period controls a voltage charging level of a reference voltage associated with the transistor and the deactivation period controls a voltage discharging level of the reference voltage associated with the transistor.
